(19) United States
(12) Patent Application Publication
(10) Pub. No.: US 2023/0206728 A1
(43) Pub. Date: Jun. 29, 2023

(54) SYSTEM AND METHOD FOR PROVIDING GAMBLING EXPERIENCE BASED ON LIVE, RECORDED, OR SIMULATED EVENT

(71) Applicant: James Patrick ROONEY, Denver, CO (US)

(72) Inventor: James Patrick ROONEY, Denver, CO (US)

(21) Appl. No.: 17/816,684

(22) Filed: Aug. 1, 2022

Related U.S. Application Data
(60) Provisional application No. 63/227,549, filed on Jul. 30, 2021.

(51) Int. Cl. G07F 17/32

(52) U.S. Cl. CPC G07F 17/3288; G07F 17/323; G07F 17/3211

(57) ABSTRACT

A system and method provide a gambling experience for a user based on a live, recorded or computer-generated event. A system includes a user interface and a processor communicatively coupled to the user interface. The processor is adapted to receive or determine a predetermined starting situation; provide a plurality of bet options adapted to predict a result of an action in the event following the predetermined starting situation; receive one or more bets from at least one user via the user interface; receive or determine an outcome of the action in the event; determine a result of the one or more bets based on the outcome of the action in the event, and provide bet results to the user.

### CROSS-REFERENCE TO RELATED APPLICATIONS

This application claims the benefit of U.S. Provisional Application No. 63/227,549 entitled “System and Method for Providing Gambling Experience based on Live, Recorded, or Simulated Event” and filed on Jul. 30, 2021, which is incorporated by reference in its entirety as if fully set forth herein.

### BACKGROUND

### Field

The instant disclosure relates to a system and method for providing a gambling experience based on a live, recorded or simulated event.

### Background

Fantasy sports are an increasingly popular activity that simultaneously enhance interest in the corresponding sports.

### SUMMARY

In one embodiment, a system and method provide a gambling experience for a user based on a live, recorded or computer-generated event. A system includes a user interface and at least one processor communicatively coupled to the user interface. The processor is adapted to receive or determine a predetermined starting situation; provide a plurality of bet options adapted to predict a result of an action in the event following the predetermined starting situation; receive one or more bets from at least one user via the user interface; receive or determine an outcome of the action in the event; determine a result of the one or more bets based on the outcome of the action in the event, and provide bet results to the user.

In another embodiment, a method provides a gambling experience for a user based on a live, recorded or computer-generated event. The method comprising: receiving or determining a predetermined starting situation; providing a plurality of bet options adapted to predict a result of an action in the event following the predetermined starting situation; receiving one or more bets from at least one user via a user interface; receiving or determining an outcome of the action in the event; determining a result of the one or more bets based on the outcome of the action in the event, and providing bet results to the user.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a block diagram showing an embodiment of a system for providing a gambling experience based on a live event.

FIG. 2 is a schematic representation of a gaming interface (e.g., an electronic display or game board such as a casino game table) for providing a gaming experience based on an example event comprising a football game or simulation.

FIG. 3 is a block diagram showing an embodiment of a system for providing an interactive gaming experience based on an event, such as a live event, a prior event, or a simulated event.

FIG. 4 is a flowchart showing an example method of providing a gaming experience based on a live, recorded, or simulated football game. In this embodiment, a live event is displayed in real-time.

FIG. 5 is a block diagram showing an example fantasy coaching mobile application system in which one or more players are able to bet in a mobile application environment.

FIG. 6 shows an example user interface display for an electronic table game or mobile application adapted to allow a user to place one or more bets during a live, recorded, or simulated game play.

FIG. 7 is a block diagram showing an embodiment of a system architecture adapted to provide an Electronic Table Game and/or a mobile live gameplay.

FIG. 8 is a flowchart showing example operations that may be executed on the system architecture shown in FIG. 7.

FIGS. 9 through 12 show example Graphical User Interfaces for betting operations in the system.

FIG. 13 is a block diagram showing an embodiment of a system architecture adapted to provide a mobile simulated gameplay.

FIG. 14 shows an example graphical user interface adapted to allow a player to predict whether the offense or defense will win the play.

FIG. 15 shows an example graphical user interface adapted to allow a player to predict whether the play will be a run or a pass.

FIG. 16 shows an example graphical user interface adapted to allow a player to predict which part of the field the next play will go across the field.

FIG. 17 shows an example graphical user interface adapted to allow a player to predict which part of the field the next play will go down the field.

FIG. 18 shows an example graphical user interface adapted to allow a player to predict whether something particularly exciting or impactful will happen on the play, and which team will make an impact play.

FIG. 19 shows an example graphical user interface adapted to show results of the player’s one or more predictions.

FIG. 20 shows an example graphical user interface adapted to an example Fantasy Coaching Baseball game variation.

FIG. 21 shows an example Gameplay Flow Diagram adapted to an example Fantasy Coaching Baseball Game Variation.

FIG. 22 shows an example graphical user interface adapted to an example Fantasy Coaching Cricket game variation.

FIG. 23 shows an example Gameplay Flow Diagram adapted to an example Fantasy Coaching Cricket Game variation.

FIG. 24 shows an example graphical user interface adapted to an example Fantasy Coaching Tennis Game variation.

FIG. 25 shows an example Gameplay Flow Diagram adapted to an example Fantasy Coaching Tennis Game variation.

FIG. 26 shows an example graphical user interface adapted to an example Fantasy Coaching Basketball Game variation.

FIG. 27 shows an example Gameplay Flow Diagram adapted to an example Fantasy Coaching Basketball Game variation.

### DETAILED DESCRIPTION

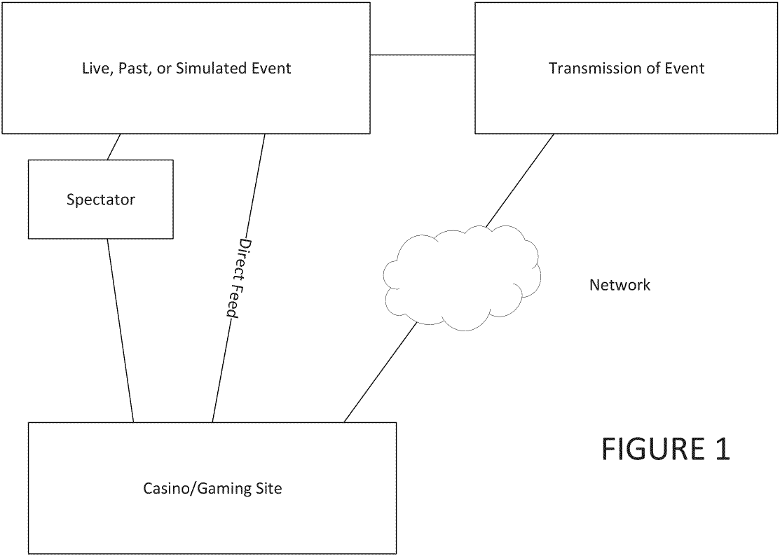

FIG. 1 is a block diagram showing an embodiment of a system for providing a gambling experience based on a live event. The live event, for example, may comprise a sporting event such as but not limited to football, soccer, baseball, cricket, basketball, tennis, or the like. A gaming site or host, such as a casino, a mobile application or electronic table game host, is linked via one or more communications links to the live event. In the embodiment shown in FIG. 1, for example, the gaming site is linked to the event via one or more of a live broadcast, stream, game cast, simulcast, or other transmission of the event, a direct feed to the event, and a spectator at the event. A transmission of the event may include video, audio, and/or other information associated with the event transmitted over a network, public airway, or other carrier. A network, for example, may include at least one of the Internet, a cable network, a satellite network, or the like. The direct feed may include a feed coupled to the event, whether controlled by an official related to the event or a spectator associated with the gaming site. In this embodiment, the gaming site can receive information from the event via any one or more of these links.

The gaming site or host then provides one or more gambling experience based on the event. The gaming experience, for example, may comprise a table game, an electronic table game, or a mobile application.

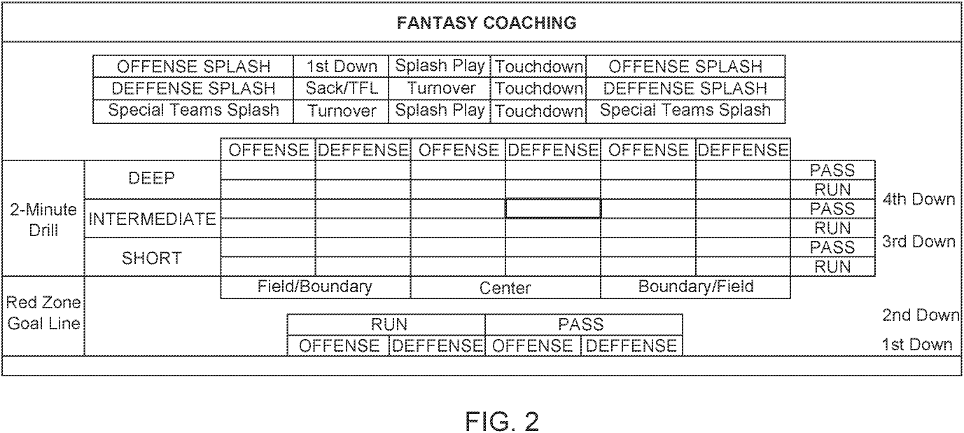

FIG. 2 is a schematic representation of a gaming interface (e.g., an electronic display or game board such as a casino game table) for providing a gaming experience based on an example event comprising a football game or simulation. In this embodiment, the interface includes a number of options for betting within the gaming experience. In this particular embodiment, the interface comprises a fantasy coaching interface where one or more users may interact with the gambling experience by placing one or more bets on one or more scenarios within the football game. The bets, in this example, include selecting whether a play is a run or a pass, and whether the offense or defense is successful on the play. In one embodiment, for example, the offense may be determined to be successful if the play results in a gain of greater than or equal to three yards from a line of scrimmage at the start of the play, and the defense may be determined to be successful if the play results in a gain of less than three yards from the line of scrimmage at the start of the play. This is merely an example criterion, however, and any success criteria may be used in various embodiments of the gaming experience.

The gaming interface in this example also includes a field location for the play whereby the players may predict the direction of the play and various results of the play. For example, the players may select a direction, such as right, left, and center. The left right and center directions may be defined as from the left field boundary to the left hashmark as a left direction, between the left and right hashmarks as center, and from the right hashmark to the right field boundary as right. In one embodiment, for example, the direction of the play may be determined by an outcome of the play, such as where the ball is spotted by an official at the end of the play. For example, if the ball is placed on a left hashmark (the play is determined as “left”), on a right hashmark (the play is determined as “right”), and the ball is placed between the left and right hashmarks (the play is determined as “center”). The gaming interface further includes options for betting on the length of play, such as short, intermediate, and long. Again, criteria for determining the outcome of the distance is predetermined (e.g., less than five yards for short, between five and ten yards for intermediate, and greater than ten yards for long). In this embodiment, the interface further includes options for selections of Run or Pass for each of the distance options, and further includes options for whether the Offense or Defense is successful. In one embodiment, for example, successful plays by the offense include gaining at least a predetermined yardage without a turnover, scoring plays, first downs, and successful plays by the defense include the offense failing to gain the predetermined yardage, a turnover, or an incomplete pass.

The interface also includes special situational betting options, such as a two-minute drill, a Red Zone/Goal Line option, and a Possession Down Phase represented on a game board as 3rd down and 4th down boxes in the Field or Gridiron section of the game board. The two-minute drill option provides a potential fast-paced option for betting on accelerated plays in a football game providing the possibility of increased excitement and activity. The Red Zone/Goal Line options further provide options for betting on scoring opportunities. Examples of these options are described below with respect to specific embodiments of systems for providing gambling experiences.

In this embodiment the interface also includes Offense, Defense, and Special Teams Splash Plays for increased betting options. These Splash Play options, for example, may include a Trick Play, a Sack or Tackle for Loss, a Turnover, and a Touchdown. The Splash Plays may also be unit-specific for Offense, Defense, and Special team units of each team involved in the football game.

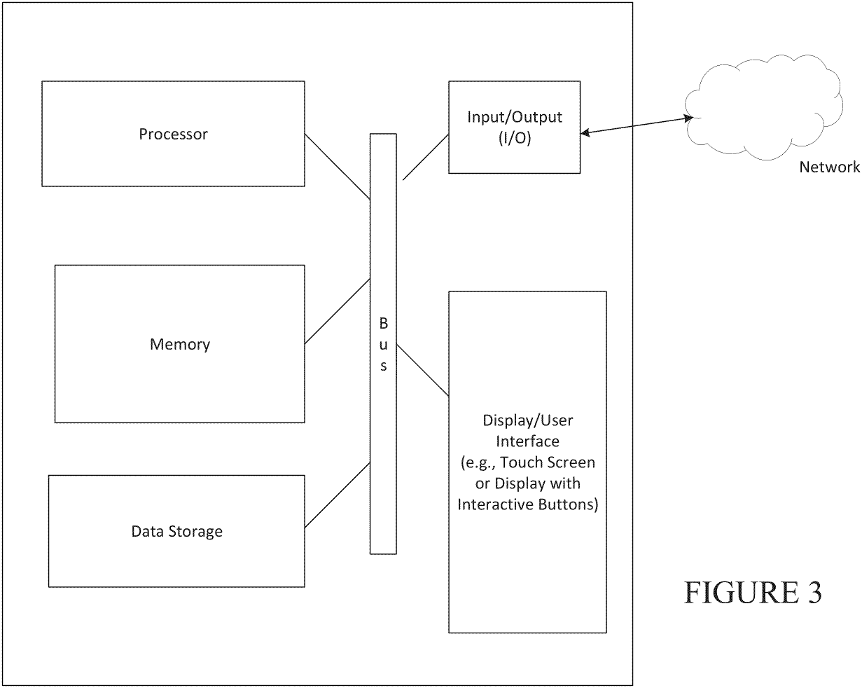

FIG. 3 is a block diagram showing an embodiment of a system for providing an interactive gaming experience based on an event, such as a live event, a prior event, or a simulated event. In this embodiment, the system comprises a processor adapted to execute software to provide the gaming experience for a user. The processor is connected to other elements of the device, such as via a bus or other communication media. The bus, in this example, couples the processor to an input/output (I/O) device that is adapted to receive information, such as from a network, related to the event. The network, for example, may correspond to the network shown in the embodiment shown in FIG. 1. The system further includes a memory and/or other data storage adapted to store the software instructions as well as data, such as for the event that is the basis for the gambling experience. In this embodiment, the system also includes a user interface, such as a touch display, one or more buttons or other interactive devices for receiving inputs from the user and/or providing outputs to the user.

### Gambling Game Modes

In one embodiment, Fantasy Coaching is offered as a gambling game at locations such as but not limited to physical casinos as well as digital sports books. Example embodiments of wagering game modes include monetary and non-monetary (e.g., points) options and modes of play including a Player versus House mode, a Player versus Player mode, a Team versus Team mode, and a Player versus Handicapper mode. Each of these game modes may be hosted as either a physical table game, an electronic table game, or a software application for mobile or at-home devices.

In one embodiment, for example, a wagering mode of a Fantasy Coaching game is a Player versus House game in which one or more individual Fantasy Coaching Players wager against House set odds as often as on each individual play of a football game (live game, video clips of past games, computer simulated plays, or other). Each individual play of the football game that is the subject of wagering in the Fantasy Coaching game is considered an independent event. The House (casino, Fantasy Coaching game host, etc.) will open a betting period before each individual play of the football game. In one embodiment, the House may set, reset, or readjust the odds on the Fantasy Coaching Game Board for each play of the football game. Players will have the opportunity to place wagers on their predicted play result before each play of the football game. The House will end the betting period before the football play begins at the snap of the football. The House will establish an actual play result and compare each Players’ wager to the actual play result to determine wins (payouts) and losses. The House will then open a new betting period and repeat the cycle for the next or any subsequent play in the football game. An example of processes for opening/closing betting periods, establishing play results, and paying out/collecting wagers is detailed below in the Fantasy Coaching Detailed Dealer Procedures.

In another embodiment, a Player versus Player mode is provided in which the Fantasy Coaching Players wager against other Fantasy Coaching Players (e.g., individual players against other individual players). In this mode, every Player at the Fantasy Coaching Game Table/ETG Area can buy into a certain number of plays in the football game or buy into a particular series in the football game. In that series or set of plays, the players predict the outcome of each play following the same Fantasy Coaching Gameplay procedure as the Player vs. House version. Instead of winning money on each individual prediction, Players can win the “pot” of money, the sum of each player’s buy in minus a percentage that the house takes off the top as a service fee, when they predict the most plays correctly in the set/series.

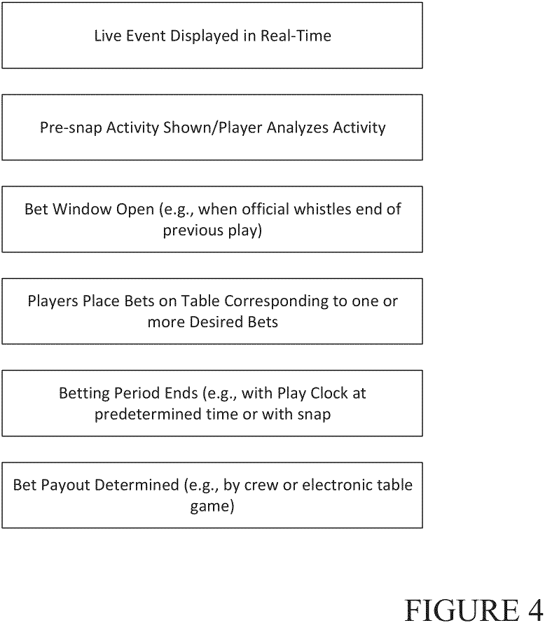

FIG. 4 is a flowchart showing an example method of providing a gaming experience based on a live, recorded, or simulated football game. In this embodiment, a live event is displayed in real-time. This display, for example, may be on a display at a live casino table game, on a display of an electronic table game, and/or on one or more displays of a computing device (e.g., smartphone, tablet, personal computer) via an application (e.g., mobile application) or other software.

Pre-betting activity may be shown during which players can analyze the activity or other information and determine a betting strategy before a betting period ends. In the football game example, the pre-betting activity may include pre-snap activity, such as player substitutions, player groups, huddle, coaching activity, formations, or the like.

A betting window is opened during which gaming players may place one or more bets. This betting window, for example, may overlap with the pre-betting activity shown. In one embodiment, for example, the betting window may be initiated when an official blows a whistle at the end of a previous play.

During the betting window, the gaming players may place one or more bets, such as on a gaming table in a live casino gaming environment, via a display of an electronic table game or via a display of a mobile application on their device.

A betting period ends ending the gaming players abilities to place any more bets on the next play, such as at a predetermined time on a game clock or with a live snap.

A bet payout is determined based on a result of the live, recorded, or simulated event, such as at the end of a play. The bet payout may be determined by a casino crew, an electronic table game, or a software host (e.g., for a mobile application).

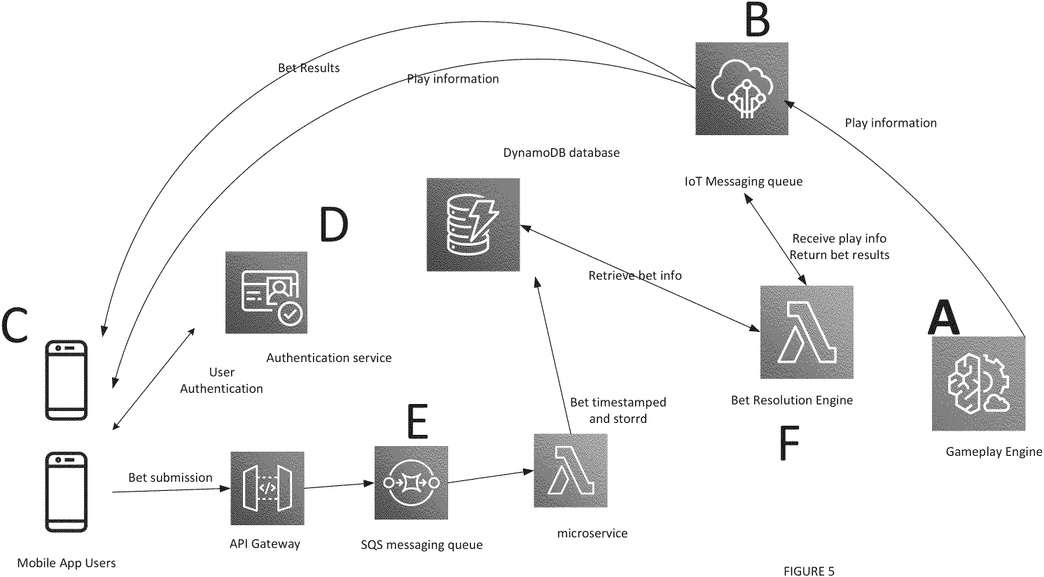

FIG. 5 is a block diagram showing an example fantasy coaching mobile application system in which one or more players are able to bet in a mobile application environment. The mobile application environment, for example, may comprise a standalone system or operate in conjunction with a casino table game and/or electronic table game multi-gaming system in which mobile gaming players may participate with other players at a casino, digital sports book or other gaming site or platform.

As shown in FIG. 5, Game state engine (A) is provided. The Game state engine (A) is adapted to execute an API, parse game commands (e.g., JSON), and write messages to one or more queues. In a football gaming example, the Game state engine (A), for example, may be adapted to execute an NFL play API, parse game JSON, write next play to IOT Message queues. The Game state engine (A) in this embodiment is adapted to run games off both live game feed data and historical or simulated games.

One or more message queues, such as IoT Message queues (B), are adapted to create messaging subscription(s) are created for each individual game. IoT rules are adapted to route copies of gameplay messages to analytical services and a play results engine (F) for processing. In this embodiment, all messages are encrypted and only accessible to registered and authenticated IoT consumers.

A Fantasy Coaching Application (C) is provided. The Fantasy Coaching Application (C) is adapted to authenticate users (e.g., against secure Cognito user pools(D)). Authenticated users may acquire one or more authentication token required to allow bet submission via the Fantasy Coaching App (C). The Mobile app (C) presents users with active games to choose from, based on selection, subscribe to IoT subscription for a desired game (B) and get gameplay data used by the application to display gameplay data for betting.

In this embodiment, an Authentication service (D) provides the user authentication, such as via Cognito user pools.

Bets may be submitted from the Fantasy Coaching Application (C) via an API gateway, SQS queue(s), a Lambda trigger microservice in which bets are timestamped and stored in a database, such as a DynamoDB database.

Authenticated users submit bets via the Fantasy Coaching Application (C) to the API gateway with security token to restrict access. Bets are sent to a SQS queue, which provides durable, secure encrypted storage of bets until consumed by Lambda micro services which timestamp the bets and write them to a database, such as Dynamodb tables, for storage and post bet processing.

A Play results engine (F) is adapted to Gets play results(B), query all play bet records for that game play result (E) and determine play bet outcome. After evaluating bets, the Play results engine (F) is adapted to update user balances, log results, and send results messages to IoT message queue specific to the authenticated user placing the bet (B).

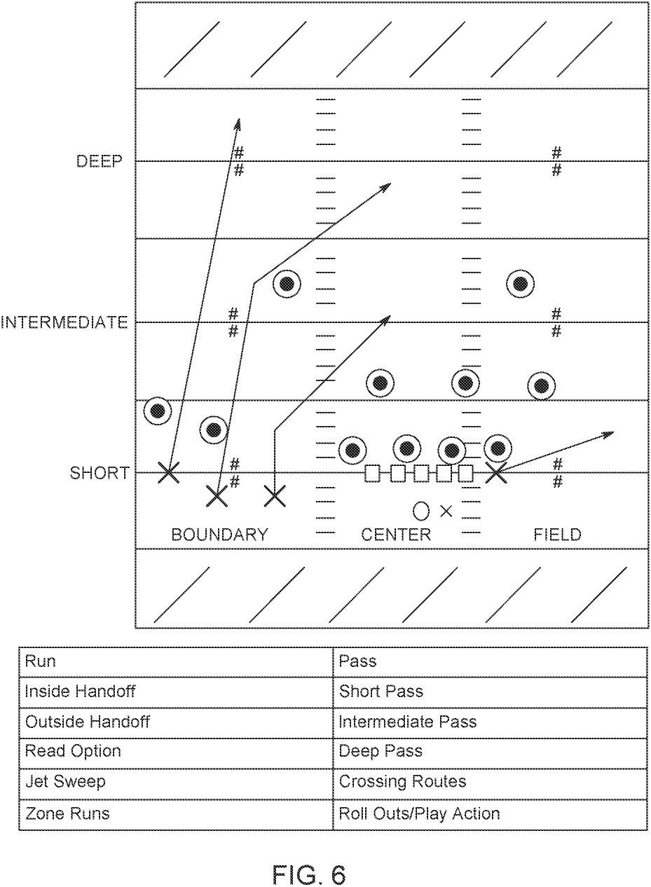

FIG. 6 shows an example user interface display for an electronic table game or mobile application adapted to allow a user to place one or more bets during a live, recorded, or simulated game play. In this embodiment, a Gridiron Hypothesis Heuristic display is provided in which the Gridiron display is adapted to offer detailed betting opportunities. The Gridiron Hypothesis Heuristic Display, for example, may be adapted to assist a user in processing one or more detailed betting opportunity to allow decision and betting activity during a fast-paced live, recorded, or simulated game play. In this embodiment, the Gridiron Hypothesis Heuristic interface is adapted to provide a feature in which a player can program a multi-bet (e.g., three-bet) option into a game play. In one example, the interface may be adapted to provide:
a. Players form a couple of hypotheses about what a team might do in a given situation (e.g., every 3rd down) and whether it will work.
b. They use their hypotheses to pre-select areas of the gridiron they will likely bet on plays that start in that given situation (e.g., 3rd down plays)
c. Every time that situation occurs (e.g., every 3rd down), shadow chips appear in those boxes of the gridiron
d. Players select which of their guesses they want to bet on in that situation and place the actual bet

A “Playcalls” button can be adapted to display in the same area of the gameboard where the stoplight usually displays every time gameplay in an actual football game stops (timeouts). Players can select the “Playcalls” button to program and update their auto-bets. In another embodiment, players with Fantasy Coaching Accounts/Profiles could set different auto-bet play calls in advance of gameplay for all of the different teams in a similar manner to fantasy sports players adjust a Fantasy Football lineups.

In one embodiment, a Playcall screen interface provides the following details:
When players select the “Playcalls” button to set or adjust their predictions, the gridiron can expand to take up the majority of the screen
The top of the screen displays a horizontal menu of different situations players might set auto-bets for
   Possession Downs
   Red Zone
   2-minute drill
   1st & 10
   Short yardage
   Behind the sticks
   Custom by down & distance, yardline, game clock, score?
The right side of the screen displays a vertical menu of different play concepts players could use to generate their hypotheses about where the ball might go on different plays
   Pass
      Short pass
      Intermediate Pass
      Deep Pass
      Crossers/Mesh
      Spacing
      Roll outs/boots/play action
      Screens
   ◯ Run
      Inside Handoff
      Outside Handoff
      Read Option
As players select each play concept, the play displays on the gridiron.
Players can use the display to see which sections of the gridiron they think plays will go to in that situation.

FIG. 6 shows the example user interface display for an electronic table game or mobile application adapted to allow a user to place one or more bets during a live, recorded, or simulated game play. In this embodiment, a Splash Play Hypothesis Heuristic display is provided in which the Splash Play display is adapted to offer detailed betting opportunities. The Splash Play Hypothesis Heuristic Display, for example, may be adapted to assist a user in processing one or more detailed betting opportunity to allow decision and betting activity during a fast-paced live, recorded, or simulated game play. In this embodiment, the Splash Play Hypothesis Heuristic interface is adapted to provide a feature in which a player can program a multi-bet (e.g., three-bet) option into a splash play phase of game play.

A Splash Play phase may offer betting opportunities on less common outcomes during a game. The Splash Play Hypothesis Heuristic display is adapted to assist a player in making bets during these less common situations, especially in a limited time frame in which the bets may be placed. The Splash Play Hypothesis Heuristic display, for example, may provide one or more features in which a player can program one or more auto-bet options into a game. In one embodiment, for example, a player can form one or more hypotheses about particular situations in which they might expect splash-type plays to happen in game play. The user interface display is adapted to allow a user to use their hypotheses to pre-select Splash Play options they will likely bet on when plays start in that given situation (e.g., 3rd down plays - Sack). Each time that situation occurs (e.g., every 3rd down), shadow chips appear on that Splash option (e.g., Sack). Players select which of their hypotheses they want to bet on in that situation and place the actual bet during game play.

A “Playcalls” button could display in the same area of the gameboard where the stoplight usually displays every time gameplay in the actual football game stops (timeouts). Players can select the “Playcalls” button to program and update their auto-bets. In one embodiment a Playcalls button provides the following details:
When players select the “Playcalls” button to set or adjust their predictions, the gridiron would expand to take up the majority of the screen
The top of the screen would display a horizontal menu of different situations players might set auto-bets for:
   Possession Downs
   Red Zone
   2 minute drill
   1st & 10
   Short yardage
   Behind the sticks
   Custom by down & distance, yardline, game clock, score?
The left side of the screen would display a small menu on which players select whether they want to set auto-bets in the Gridiron or in the Splash Play Bar.
The right side of the screen would display a vertical menu of different play concepts players could use to generate their hypotheses about where the ball might go on different plays.
   Pass
      Short Pass
      Intermediate Pass
      Deep Pass
      Crossers/Mesh
      Spacing
      Roll outsBoots/Play Action
      Screens
   ◯ Run
      Inside Handoff
      Outside Handoff
      Read Option
As players select each play concept, the play displays on the gridiron
Players can use the display to see which sections of the gridiron they predict plays will go to in that situation.

### Synchronized Live Gameplay

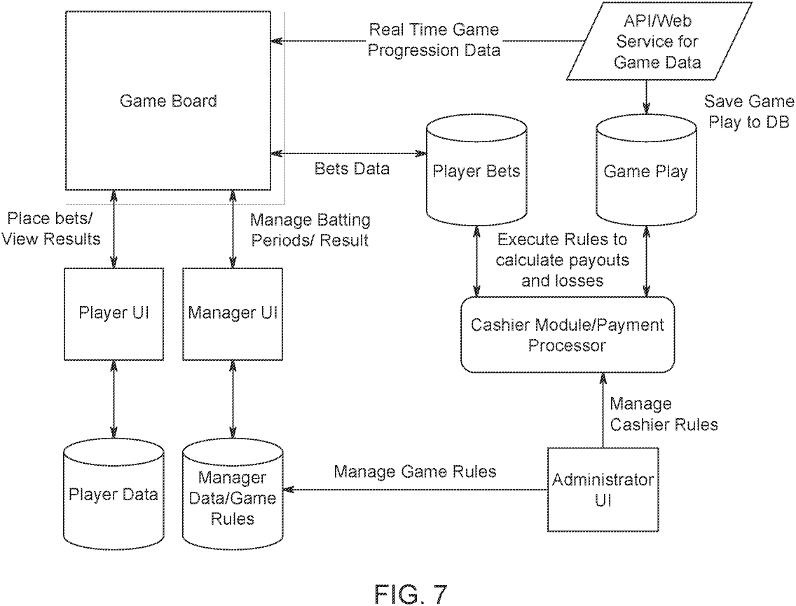

FIG. 7 is a block diagram showing an embodiment of a system architecture adapted to provide an Electronic Table Game and/or a mobile live gameplay. The electronic table game version of the game is hosted on video screen kiosks inside of physical casinos or other locations. The mobile application version of the game is hosted on casino igaming mobile applications. For both versions, the game includes a Graphical User Interface for interacting with a user. In this embodiment, the Electronic Table Game or mobile live gameplay is adapted to be synchronized to a Game Cast API or other live data feed or stream. In this embodiment, a Fantasy Coaching Game comprises a mobile application that hosts a player versus house game in which one or more individual Fantasy Coaching players wager against house set odds as often as on each individual play of a live football game. Players predict the play type, play direction, and play result of each upcoming play by designating their wagers on the Fantasy Coaching Game Board. The application is a mobile application with a Graphical User Interface with controls such as touch controls allowing users to interact with the Fantasy Coaching Game Board. In one embodiment, the application is divided into 4 modules, each with a unique set of privileges and function.

Administrator: This module can only be accessed by the application owner and would have the highest privileges to the application. This module allows the application owner or administrator to create and manage the game manager/host profiles, grant them relevant permissions, and set game rules and conditions to apply the rules. It would also allow the administrator to ban or reinstate players if needed. Any updates or new versions of the applications could be installed and managed through the administrator module.

Managers: The Manager is the game host and could also fulfill the role of a referee. The manager is adapted to open and close betting periods, open and close sections on the game board for placing bets, and apply the rules based on certain conditions. Most of the rules can be automatically applied based on the game progression; however, the manager could override certain rules or manage their application. After each play, the manager acting as a referee could determine and certify the result and announce winners and losers on the screens.

Players: The player module is adapted to allow players to create and manage their profiles. They could link to the casino’s player tracking systems if available. The module allows players to place bets, view outcomes, track their individual progress, and handle wins and losses. This module keeps track of player points, play history, preferences, tier level, and demographic information.

Cashier: This module is adapted to compare player wagers against the actual play result. The cashier module is configured to determine payouts for wins and to collect losses. This module also logs all transactions for reporting and auditing purposes. The cashier module can allow manual intervention when implementing certain rules related to delays or reversals and could handle exceptional situations.

In this embodiment, each individual play of a football game that is the subject of wagering in the Fantasy Coaching game can be considered an independent event. The Fantasy Coaching application receives data about each individual play of the football game by connecting to an Application Programming Interface (API) and Web Service. An API and Web Service would allow the application to get near real-time game progression/play data. An API is a series of web enabled functions and programs that allows two different applications to exchange data over the internet, such as using HTTP. The application would connect to the API endpoint (a web address or port) to call the relevant function or program. The programs can have a set of input parameters which enable accurate filtering and sorting of data. Using APIs allows for reduced manpower needed to run the application and allows the application to provide a more fully automated, easily scalable model. The APIs can provide detailed documentation regarding the various functions available and how to connect to them.

An example of an existing, near real-time API is SportsDataIO. SportsDataIO covers tens of thousands of sporting events throughout the year, and services all verticals, including fantasy, sports betting, broadcast, media, and predictive modeling. The company’s APIs allow for live play-by-play updates for NFL games that are typically provided 15-20 seconds after the TV broadcast. The play-by-play data includes a breakdown of every play: a description of the play, the players that were involved, the stats earned by involved players on the play, the result of the play, and starting/ending game state info (starting/end down and distance, etc.).

In one embodiment, a Fantasy Coaching application Manager Module uses the API play-by-play updates about the down and distance of an upcoming play, the yard line the upcoming play will start on, and the time on the game clock leading into the upcoming play to initiate particular betting periods on the Player Modules. The Manager Module uses the API play-by-play updates about the yards gained or lost on a play; information about whether the play was a run or a pass, information about whether the play was a scoring play, first down play, etc.; and information about which part of the field the play ended on to establish and certify the actual play result on the Fantasy Coaching Game Board. The Cashier Module compares the actual play result to player predictions/wagers, determine payouts for correct predictions (wins), and collect incorrect wagers (losses). Player predictions, actual play results, wins, and loses all display on the Graphical User Interface.

The Fantasy Coaching application Graphical User Interface (GUI) primarily features the Fantasy Coaching Game board, a playable menu of possible outcomes of a football play including play type, play direction, and play result options. The Fantasy Coaching Game Board contains three distinct sections, which all offer different types of predictions, such as the following:

Gridiron: The Gridiron section is a grid designed to depict a football field on a casino-style game table. Each box in the Gridiron grid represents a prediction about the play type of the upcoming play in a football game (run or pass); a prediction about the area of the field the upcoming play will go to (Field, Middle, Boundary) (Short, Intermediate, Deep); and a prediction about the result of the play (Offense or Defense win). Each of these terms are defined in the Fantasy Coaching Dictionary.

Quick Play Bar: The Quick Play Bar is a set of boxes designed to offer a simplified set of prediction options for fast-paced gameplay. The boxes in the Quick Play Bar represent a prediction about the play type of the upcoming play (run or pass) and a prediction about the result of the upcoming play (Offense or Defense win). Each of these terms are defined in the Fantasy Coaching Dictionary.

Splash Play Bar: The Splash Play Bar is a set of boxes designed to offer exciting predictions about the final results of plays. The boxes in the Splash Play Bar represent predictions that the offense or defense will score a touchdown, the offense will execute a trick play, the offense will execute a splash play, the defense will record a sack or tackle for a loss, or the defense will record a turnover. Each of these terms are defined in the Fantasy Coaching Dictionary.

The Fantasy Coaching Game Board also displays gameplay information for the user. These include the following:

Player Account: The Player Account displays the player’s overall Account Balance as well as a tally of the total amount of money the player bet on the current betting period for the upcoming play.

Wager Markers: The Wager Markers in one embodiment are a set of round digital tokens, each marked with a different number and color to represent different dollar amounts or point totals for wagers players can make. Players input predictions onto the Fantasy Coaching Game Board by clicking on the Wager Marker that represents the dollar or point total amount that players want to wager, then touching the section of the game board that represents the players’ prediction. If players touch the game board multiple times, that many wager markers will be placed onto that section of the board adding up to the total wager placed.

Play Clock: The Play Clock communicates to players when the betting period for each play is open, when the betting period is closed, and what the actual result of the play was. The Play Clock displays a green stop light and the message “Place Your Bets; Bets On” when the betting period is open. The Play Clock displays a yellow stop light and the message “Finalize Your Bets; Bets On” when the betting period is open but is about to close. The Play Clock displays a red stop light and the message “Watch the Play; Bets Off” when the betting period is closed. After a play occurs, the Play Clock displays the actual result of the play, including a message about whether the play was a run or a pass, which direction the play went to across the field and down the field, and whether the offense or defense won the play. The Play Clock displays on the Player Module Graphical User Interface, but the information about “Bets On” and “Bets Off” comes from the Manager Module interpreting and certifying data from the API.

Gameplay begins on the Fantasy Coaching application when the Manager Module receives data from the API and Web Service about the starting scenario of an upcoming play from the football game. When the Manager Module receives information about the down and distance, yard line, and time on the game clock, it opens one of several Gameplay Phase betting periods on Player Module Graphical User Interfaces.

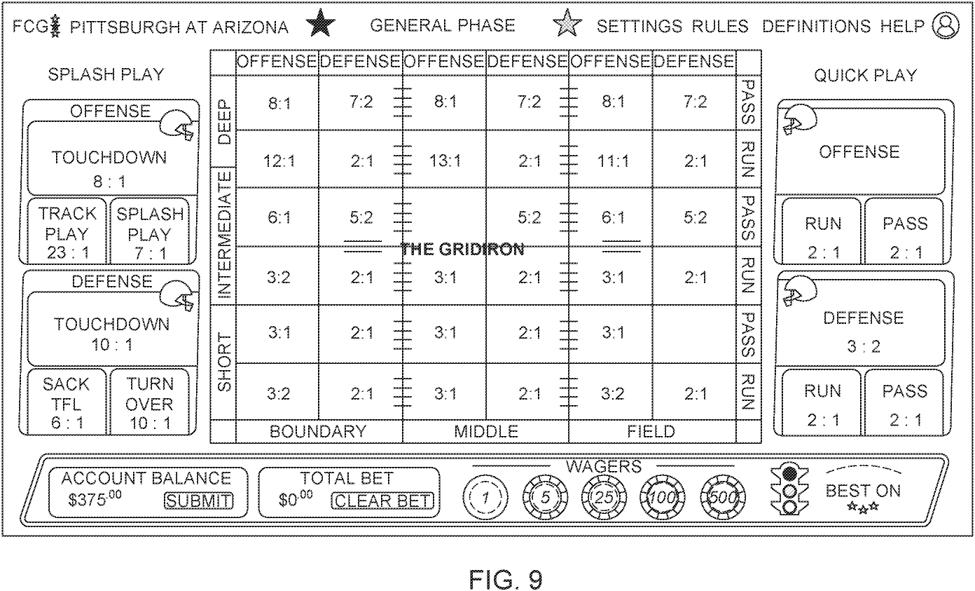

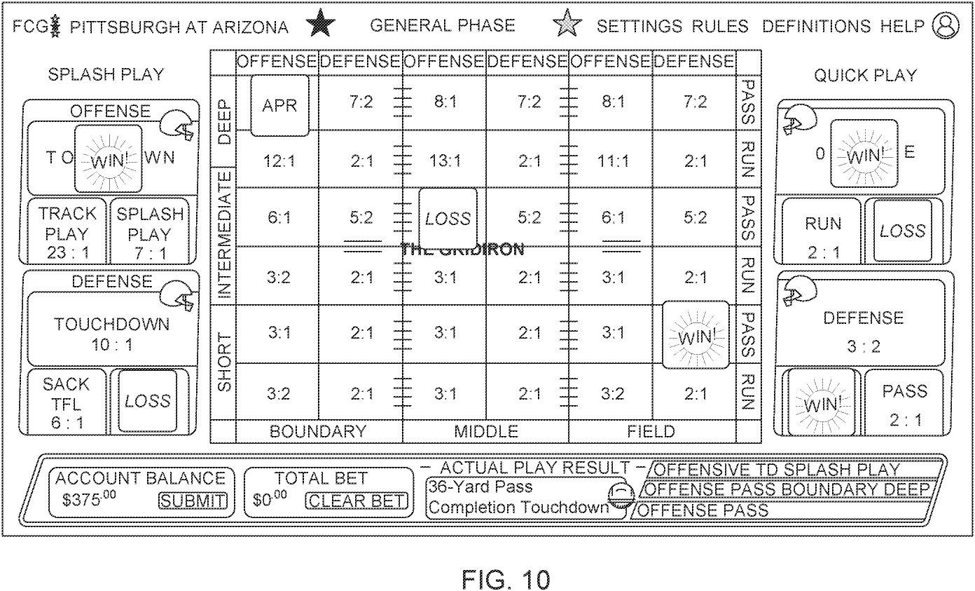

General Phase Gameplay: General Phase Gameplay occurs when the upcoming play in a football game is a 1st or 2nd down play, starting outside of the 20 yard-line from the perspective of the offense driving to score a touchdown, and before the final 2 minutes of the first half or second half. The Manager Module contains a set of rules and definitions to receive starting scenario information from the API and Web Service and interpret those scenarios as a General Phase. During General Phase Gameplay, the player interface allows players to input wagers on all three sections of the Fantasy Coaching Game Board (Gridiron, Quick Play Bar, and Splash Play Bar). FIGS. 9 and 10 show example Graphical User Interfaces for an example General Phase Gameplay.

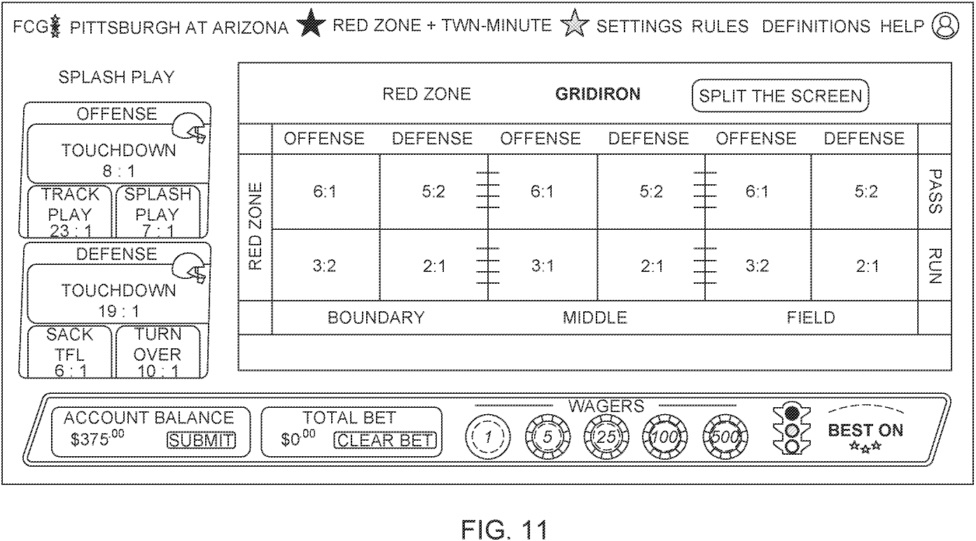

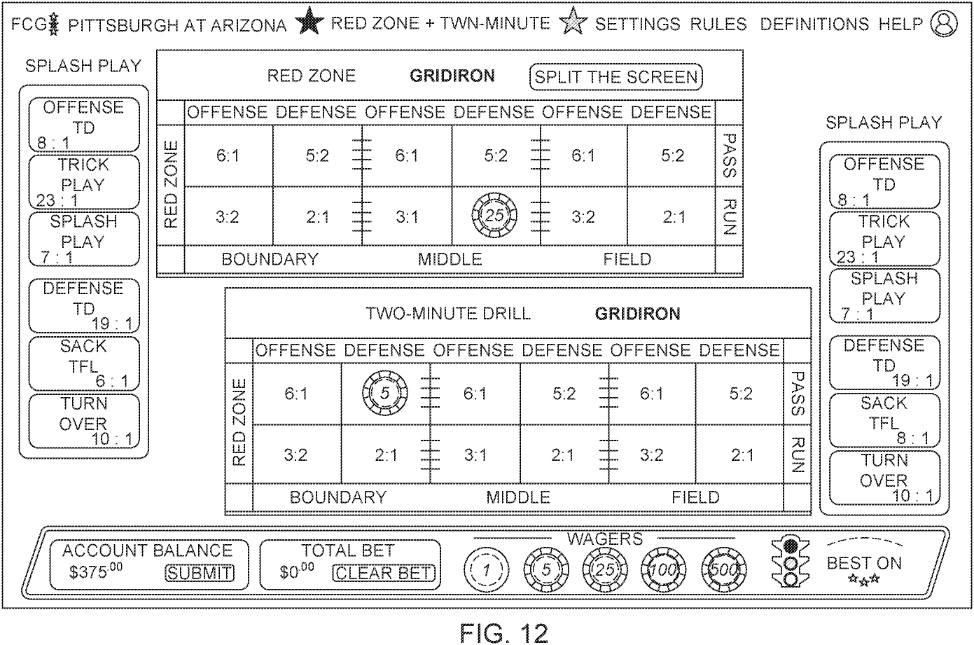

Situational Phase Gameplay: Situational Phase Gameplay occurs when the upcoming play in a football game is a 3rd or 4th down play, starting inside of the 20 yard-line from the perspective of the offense driving to score a touchdown, or occurring during the final 2 minutes of the first half or second half. The Manager Module contains a set of rules and definitions to receive starting scenario information from the API and Web Service and interpret those scenarios as a Situational Phase. During Situational Phase Gameplay, the player interface only allows players to input wagers on the Gridiron and Splash Play Bar sections of the Fantasy Coaching Game Board. The Quick Play Bar section is disabled during Situational Phases. FIGS. 11 and 12 show example Graphical User Interfaces for an example Situational Phase Gameplay.

Multi-Situational Phase Gameplay: Multi-Situational Phase Gameplay occurs when the upcoming play in a football game meets at least two of the three following scenarios: a 3rd or 4th down play, starting inside of the 20 yard-line from the perspective of the offense driving to score a touchdown, or occurring during the final 2 minutes of the first half or second half. The Manager Module contains a set of rules and definitions to receive starting scenario information from the API and Web Service and interpret those scenarios as a Multi Situational Phase. During Multi-Situational Phase Gameplay, the player interface only allows players to input wagers on the Gridiron and Splash Play Bar sections of the Fantasy Coaching Game Board. The Quick Play Bar section is disabled during Multi Situational Phases. During Multi-Situational Phase Gameplay, the player interface displays a button that allows players to split their screen into two. If players select the button, the interface displays two Gridiron sections and two Splay Play Bars to enable players to make two predictions in each section.

Free Kick Frenzy Gameplay: Free Kick Frenzy Phase Gameplay occurs when the upcoming play in a football game is a Free Kick Play (Kickoff or Safety Punt plays). The Manager Module contains a set of rules and definitions to receive starting scenario information from the API and Web Service and interpret those scenarios as a Free Kick Frenzy Phase. During Free Kick Frenzy Phase Gameplay, the player interface only allows players to input wagers on the Splash Play Bar section of the Fantasy Coaching Game Board. The Quick Play Bar and Gridiron sections are disabled during Free Kick Frenzy Phases. The Free Kick Frenzy Phase also includes a function to enable losing predictions to roll over to the next play.

Once the Manager Module sets the Gameplay Phase, a betting period opens on the Player Module Graphical User Interface. The Play Clock displays “Bets On” and players are able to touch the wager markers and deposit them onto the sections of the Fantasy Coaching Game Board that are available on that play. Once the Manager Module receives information from the API and Web Service that the offenses and defenses are lined up in formation and the Quarterback is under center, it triggers the Player UI play clock to prompt players to finalize their bets. The betting period remains open but will close soon. Once the Manager Module receives information from the API and Web Service that the ball has been snapped and the play has begun, it closes the betting period and triggers the Player UI game board to lock so that players can no longer place any bets. Once the Cashier module receives information about the result of the football play including whether the play was a run or a pass, which part of the field the play went to, and whether the offense or defense won the play, it displays the actual play result on the Player UI Game Board both on the sections of the board that represent the play result and in the Play Clock section. Then, the cashier module compares the actual results of the play to the predictions players made. The Cashier Module marks the player predictions that matched the actual play result as “Wins” on the Player UI and pays out the winnings based on the house set odds to the Player Account. The Cashier Module marks the player predictions that do not match the actual play result as “Losses” on the Player UI game board and collects the wagers from player accounts. Then, the Manager Module receives starting scenario information about the next play of the football game and opens up a new betting period on Player UI’s.

The application will save data into a set of tables that would be queried to display data on the screens, as well as perform computations. The database would have a series of functions and procedures that would perform storage, data retrieval, calculations, and report generation. The database will save all the game play data retrieved from the APIs, as well as the player bets, on a real-time basis and could be archived at certain intervals for reporting and auditing purposes. It would have a set of tables to enable logging of all events on the interface screens, including user login and logout information with timestamps. Lastly, data could be moved to a dedicated reporting database on a daily basis for Data Analytics and Data Mining tasks. Reports could be generated from the reporting database using Business Intelligence software for Management, Marketing, and Promotions.

The system architecture shown in FIG. 7 provides a Fantasy Coaching Platform in which components of the system comprise software such as the following:
Authentication for users: Cognito
Betting Console submits bets with API gateway -> SQS queue -> Lambda Trigger -> DynamoDB Receives game scores, play data and offers/messages using IOT -> MQTT based messages
Game state engine: Executes NFL play API, parses game JSON, Writes next play to DynamoDB and IOT Message queues
Play results engine: Gets play results, queries all play bet records for that game play result and determines play bet outcome Writes play results to Dynamodb, updates player balances, sends message to player via IOT MQTT message
Authentication against customer closed system player balance against a closed customer system

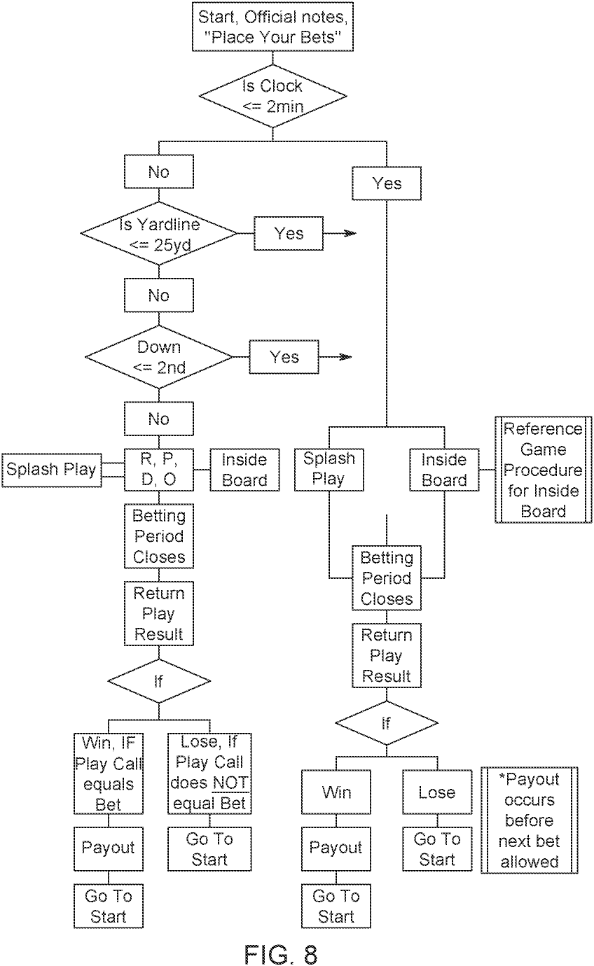

FIG. 8 is a flowchart showing example operations that may be executed on the system architecture shown in FIG. 7. FIGS. 9 through 12 show example Graphical User Interfaces for betting operations in the system.

### Simulated Gameplay

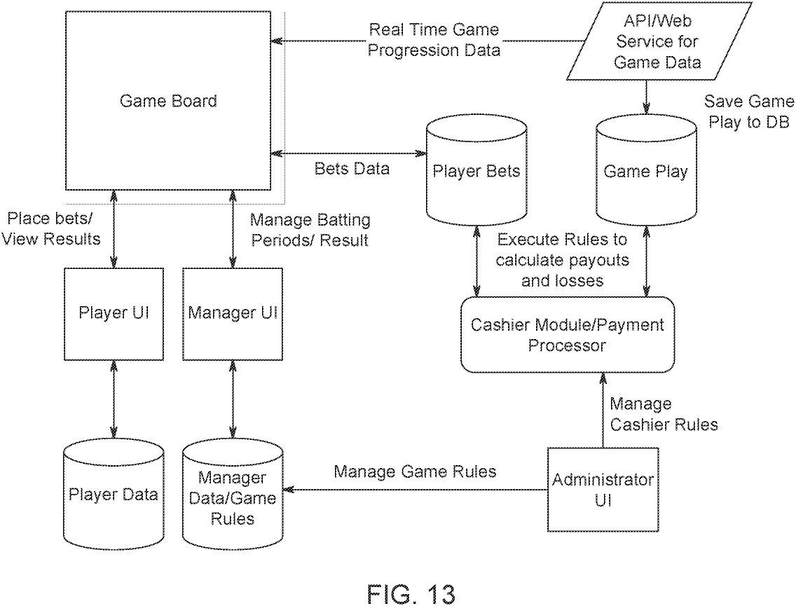

FIG. 13 is a block diagram showing an embodiment of a system architecture adapted to provide a mobile simulated gameplay. In this embodiment, the mobile simulated gameplay is adapted to be synchronized to one or more simulation and/or computer model. In this embodiment, the Fantasy Coaching Game is an Electronic Table Game and/or mobile application that hosts a player versus house game in which one or more individual Fantasy Coaching players wager against house set odds as often as on each individual play of a simulated football game. Players predict the play type, play direction, and play result of each upcoming play by designating their wagers on the Fantasy Coaching Game Board. The electronic table game version of the game is hosted on video screen kiosks inside of physical casinos. The mobile application version of the game is hosted on casino igaming mobile applications. For both versions, the game includes a Graphical User Interface with touch controls allowing users to interact with the Fantasy Coaching Game Board. The application is divided into 4 modules, each with a unique set of privileges and function.

Administrator: This module can only be accessed by the application owner and has the highest privileges to the application. This module allows the application owner or administrator to create and manage the game manager/host profiles, grant them relevant permissions, and set game rules and conditions to apply the rules. It would also allow the administrator to ban or reinstate players if needed. Any updates or new versions of the applications could be installed and managed through the administrator module.

Manager: The Manager is the game host and could also fulfill the role of a referee. The manager opens and closes betting periods, open and close sections on the game board for placing bets, and apply the rules based on certain conditions. Most of the rules would be automatically applied based on the game progression; however, the manager could override certain rules or manage their application. After each play, the manager acting as a referee could determine and certify the result and announce winners and losers on the screens.

Players: The player module would allow players to create and manage their profiles. They could link to the casino’s player tracking systems if available. The module would allow players to place bets, view outcomes, track their individual progress, and handle wins and losses. This module will keep track of player points, play history, preferences, tier level, and demographic information.

Cashier: This module compares the player wagers against the actual play result. The cashier module will be configured to determine payouts for wins and to collect losses. This module will also log all transactions for reporting and auditing purposes. The cashier module could allow manual intervention when implementing certain rules related to delays or reversals and could handle exceptional situations.

Each individual play of the simulated football game that is the subject of wagering in the Fantasy Coaching game may be considered an independent event. The Fantasy Coaching application would receive data about each individual play of the football game by connecting to the data stream from a video game or computer model. Video games (e.g., Madden) and computer models can be used to simulate potential live events (football games) at a high level of specificity and authenticity. A video game can be adapted to display and simulate full-length football games involving 11 players on offense, 11 players on defense. The game can simulate the virtual offense running an actual play call against the virtual defense, also running an actual defensive call. It simulates each of the 11 players in each unit performing their actual responsibility in the called play at the represented players set skill level. It shows the play unfold according to its model and shows the actual play result. Throughout the course of these simulated games, the systems are able to continually track and update the starting situations of each play (down and distance, ball placement yard line, game clock) and actual play results (yards gained/lost, run versus pass, direction of the play).

The video game simulation/computer model can generate a visual of an offensive team against a defensive team. It can also generate a play call for the Offense and the Defense. The visual of the team’s starting formations and the starting scenario of the play are displayed on the Fantasy Coaching ETG or application alongside the Fantasy Coaching Game Board. Fantasy Coaching players can customize the different teams, players, and playbooks involved in the simulated game, including teams, players, and playbooks from different eras.

The Fantasy Coaching Application Manager Module uses the football game simulation play-by-play updates about the down and distance of an upcoming play, the yard line the upcoming play will start on, and the time on the game clock leading into the upcoming play to initiate particular betting periods on the Player Modules. The Manager Module uses the simulation play-by-play updates about the yards gained or lost on a play; information about whether the play was a run or a pass, information about whether the play was a scoring play, first-down play, etc.; and information about which part of the field the play ended on to establish and certify the actual play result on the Fantasy Coaching Game Board. The Cashier Module compares the actual play result to player predictions/wagers, determine payouts for correct predictions (wins), and collect incorrect wagers (losses). Player predictions, actual play results, wins, and loses all display on the Graphical User Interface.

The Fantasy Coaching Application Graphical User Interface primarily features the Fantasy Coaching Game board, a playable menu of possible outcomes of a football play including play type, play direction, and play result options. The Fantasy Coaching Game Board contains three distinct sections, which all offer different types of predictions:

Gridiron: The Gridiron section is a grid designed to depict a football field on a casino-style game table. Each box in the Gridiron grid represents a prediction about the play type of the upcoming play in a football game (run or pass); a prediction about the area of the field the upcoming play will go to (Field, Middle, Boundary) (Short, Intermediate, Deep); and a prediction about the result of the play (Offense or Defense win). Each of these terms are defined in the Fantasy Coaching Dictionary.

Quick Play Bar: The Quick Play Bar is a set of boxes designed to offer a simplified set of prediction options for fast-paced gameplay. The boxes in the Quick Play Bar represent a prediction about the play type of the upcoming play (run or pass) and a prediction about the result of the upcoming play (Offense or Defense win). Each of these terms are defined in the Fantasy Coaching Dictionary.

Splash Play Bar: The Splash Play Bar is a set of boxes designed to offer exciting predictions about the final results of plays. The boxes in the Splash Play Bar represent predictions that the offense or defense will score a touchdown, the offense will execute a trick play, the offense will execute a splash play, the defense will record a sack or tackle for a loss, or the defense will record a turnover. Each of these terms are defined in the Fantasy Coaching Dictionary.

The Fantasy Coaching Game Board also displays gameplay information for the user. These include:

Player Account: The Player Account displays the player’s overall Account Balance as well as a tally of the total amount of money the player bet on the current betting period for the upcoming play.

Wager Markers: The Wager Markers, for example, may comprise a set of round digital tokens, each marked with a different number and color to represent different dollar amounts or point totals for wagers players can make. Players input predictions onto the Fantasy Coaching Game Board by clicking on the Wager Marker that represents the dollar or point total amount that players want to wager, then touching the section of the game board that represents the players’ prediction. If players touch the game board multiple times, that many wager markers will be placed onto that section of the board adding up to the total wager placed.

Play Clock: The Play Clock communicates to players when the betting period for each play is open, when the betting period is closed, and what the actual result of the play was. The Play Clock displays a green stop light and the message “Place Your Bets; Bets On” when the betting period is open. The Play Clock displays a yellow stop light and the message “Finalize Your Bets; Bets On” when the betting period is open but is about to close. The Play Clock displays a red stop light and the message “Watch the Play; Bets Off” when the betting period is closed. After a play occurs, the Play Clock displays the actual result of the play, including a message about whether the play was a run or a pass, which direction the play went to across the field and down the field, and whether the offense or defense won the play. The Play Clock displays on the Player Module Graphical User Interface, but the information about “Bets On” and “Bets Off” comes from the Manager Module interpreting and certifying data from the simulation.

Gameplay begins on the Fantasy Coaching application when the Manager Module receives data from the football game simulation about the starting scenario of an upcoming play from the football game. When the Manager Module receives information about the down and distance, yard line, and time on the game clock, it opens one of several Gameplay Phase betting periods on Player Module Graphical User Interfaces.

General Phase Gameplay occurs whenever the upcoming play in a football game is a 1st or 2nd down play, starting outside of the 20 yard-line from the perspective of the offense driving to score a touchdown, and before the final 2 minutes of the first half or second half. The Manager Module contains a set of rules and definitions to receive starting scenario information from the simulation and interpret those scenarios as a General Phase. During General Phase Gameplay, the player interface allows players to input wagers on all three sections of the Fantasy Coaching Game Board (Gridiron, Quick Play Bar, and Splash Play Bar).

Situational Phase Gameplay occurs whenever the upcoming play in a football game is a 3rd or 4th down play, starting inside of the 20 yard-line from the perspective of the offense driving to score a touchdown, or occurring during the final 2 minutes of the first half or second half. The Manager Module contains a set of rules and definitions to receive starting scenario information from the simulation and interpret those scenarios as a Situational Phase. During Situational Phase Gameplay, the player interface only allows players to input wagers on the Gridiron and Splash Play Bar sections of the Fantasy Coaching Game Board. The Quick Play Bar section is disabled during Situational Phases.

Multi-Situational Phase Gameplay occurs whenever the upcoming play in a football game meets at least two of the three following scenarios: a 3rd or 4th down play, starting inside of the 20 yard-line from the perspective of the offense driving to score a touchdown, or occurring during the final 2 minutes of the first half or second half. The Manager Module contains a set of rules and definitions to receive starting scenario information from the simulation and interpret those scenarios as a Multi-Situational Phase. During Multi-Situational Phase Gameplay, the player interface only allows players to input wagers on the Gridiron and Splash Play Bar sections of the Fantasy Coaching Game Board. The Quick Play Bar section is disabled during Multi-Situational Phases. During Multi-Situational Phase Gameplay, the player interface displays a button that allows players to split their screen into two. If players select the button, the interface displays two Gridiron sections and two Splay Play Bars to enable players to make two predictions in each section.

Free Kick Frenzy Phase Gameplay occurs whenever the upcoming play in a football game is a Free Kick Play (Kickoff or Safety Punt plays). The Manager Module contains a set of rules and definitions to receive starting scenario information from the simulation and interpret those scenarios as a Free Kick Frenzy Phase. During Free Kick Frenzy Phase Gameplay, the player interface only allows players to input wagers on the Splash Play Bar section of the Fantasy Coaching Game Board. The Quick Play Bar and Gridiron sections are disabled during Free Kick Frenzy Phases. The Free Kick Frenzy Phase also includes a function to enable losing predictions to roll over to the next play.

Once the Manager Module sets the Gameplay Phase, a betting period opens on the Player Module Graphical User Interface. The Play Clock displays “Bets On” and players are able to touch the wager markers and deposit them onto the sections of the Fantasy Coaching Game Board that are available on that play. After a period of 15 seconds, the manager module triggers the Player UI play clock to prompt players to finalize their bets. The betting period remains open for 5 more seconds. After the 20 second betting period ends, the Manager Module closes the betting period and triggers the Player UI game board to lock so that players can no longer place any bets. Once the Cashier module receives information about the result of the football play including whether the play was a run or a pass, which part of the field the play went to, and whether the offense or defense won the play, it displays the actual play result on the Player UI Game Board both on the sections of the board that represent the play result and in the Play Clock section. Then, the cashier module compares the actual results of the play to the predictions players made. The Cashier Module marks the player predictions that matched the actual play result as “Wins” on the Player UI and pays out the winnings based on the house set odds to the Player Account. The Cashier Module marks the player predictions that do not match the actual play result as “Losses” on the Player UI game board and collects the wagers from player accounts. Then, the Manager Module receives starting scenario information about the next play of the football game and opens up a new betting period on Player UI’s.

The application will save data into a set of tables that would be queried to display data on the screens, as well as perform computations. The database has a series of functions and procedures that would perform storage, data retrieval, calculations, and report generation. The database will save all the game play data retrieved from the simulations, as well as the player bets, on a real-time basis and could be archived at certain intervals for reporting and auditing purposes. It would have a set of tables to enable logging of all events on the interface screens, including user login and logout information with timestamps. Lastly, data could be moved to a dedicated reporting database (e.g., on a daily basis) for Data Analytics and Data Mining tasks. Reports could be generated from the reporting database using Business Intelligence software for Management, Marketing, and Promotions.

The system architecture shown in FIG. 13 provides a Fantasy Coaching Platform in which components of the system comprise software such as the following:
Authentication for users: Cognito
Betting Console submits bets with API gateway -> SQS queue -> Lambda Trigger -> DynamoDB Receives game scores, play data and offers/messages using IOT -> MQTT based messages
Game state engine: Executes NFL play API, parses game JSON, Writes next play to DynamoDB and IOT Message queues
Play results engine: Gets play results, queries all play bet records for that game play result and determines play bet outcome Writes play results to Dynamodb, updates player balances, sends message to player via IOT MQTT message
Authentication against customer closed system player balance against a closed customer system

### Fast-Play Free-to-Play Embodiment

A Fast-Play, Free-to-Play embodiment provides Sports book operators a method to potentially retain and convert their users into repeat igaming players. A free-to-play game is valuable because they give sports fans the opportunity to engage with sports in the specific ways they want to, including ways that do not suit the logistics and risk assumption of odds setting and betting markets. This embodiment can encourage users to log into apps more frequently and build users confidence to take more risks on gaming applications. Elements of a free-to-play embodiment include the following:
Lower the barrier to entry
Offer Sports Fans the opportunity to engage with content in the way they want to
Develop user habits to log in and engage frequently, ideally daily
Build user confidence and appetite for risk
Pivot users into the more valuable offerings —> the sport book and the igaming casino

A free-to-play embodiment lowers the barrier to entry for engagement by sequencing the prediction options offered on each play, providing an easy-to-use menu of possible responses, and simplifying the points system. The simplified points system further increases user confidence and raises their risk appetite by functioning as a gratifying feedback system. The Fantasy Coaching No Huddle game can then convert users into bettors by using the feedback system and user statistics as native prompts to show players they have a feel for certain types of predictions. The native triggers can show how much money users could be making if they were placing their predictions as bets in the sports book or igaming casino.

An embodiment of the Fantasy Coaching Game comprises a mobile application that hosts a player versus house free-to-play game in which one or more individual Fantasy Coaching players make predictions in response to prompts to win house-set point totals. Players predict the play type, play direction, and play result of each upcoming play by swiping or selecting from a menu of possible predictions on the Fantasy Coaching Fast Play User Interface. The application is an Electronic Table Game and/or mobile application with a Graphical User Interface with controls (e.g., touch controls) allowing users to interact with the Fantasy Coaching Fast Play UI.

In one embodiment, the Fantasy Coaching Game Board features three distinct sections that all offer different types of predictions. The Fantasy Coaching No Huddle UI stacks the original game board sections into a sequence of individual prediction types.

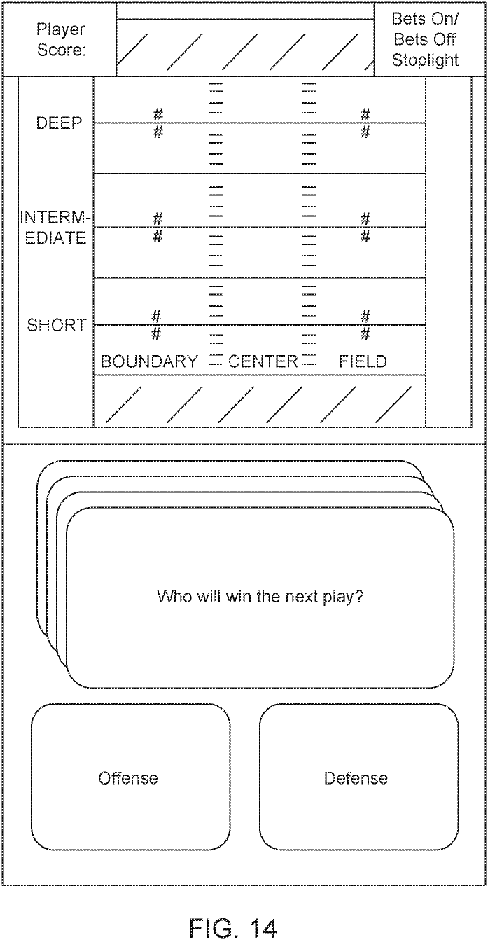

First, players will be prompted to predict the play result: will the offense or defense win the play? Players can make their prediction either by swiping left or right on the screen or by clicking the offense or defense boxes. Once players make their prediction, offense or defense will display on the gridiron graphic (football field). The Prompt will then flip to the next question and new set of options. FIG. 14 shows an example graphical user interface adapted to allow a player to predict whether the offense or defense will win the play.

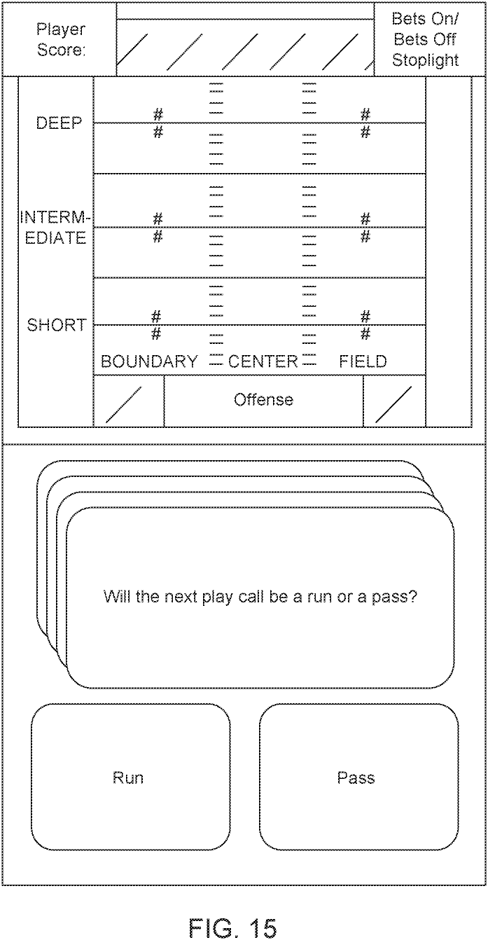

Second, players will be prompted to predict the play type: will the play be a run or a pass? Players can make their prediction either by swiping left or right on the screen or by clicking the Run or Pass boxes. Once players make their prediction, Run of Pass will display on the gridiron graphic (football field). The Prompt will then flip to the next question and new set of options. FIG. 15 shows an example graphical user interface adapted to allow a player to predict whether the play will be a run or a pass.

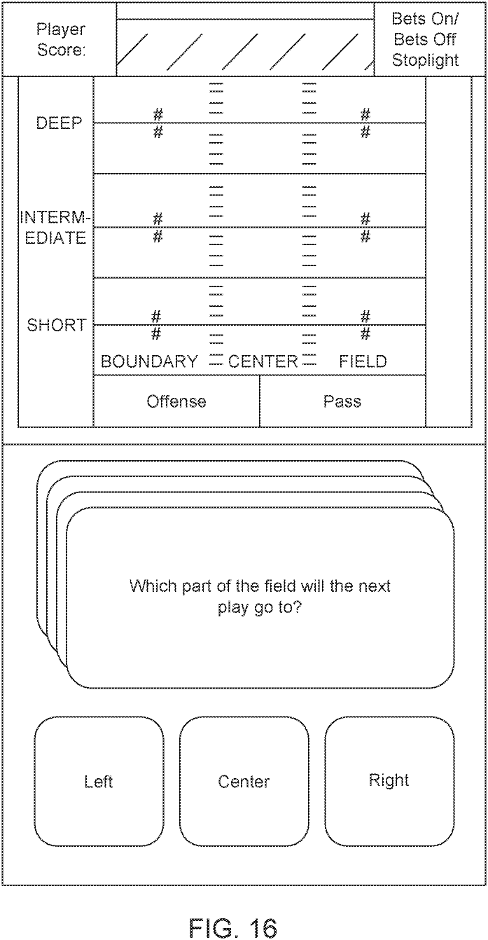

Third, players will be prompted to predict the horizontal play direction: which part of the field will the next play go to (across the field)? Players can make their prediction either by swiping up, left or right on the screen or by clicking the left, center, or right boxes. Once players make their prediction, the section of the gridiron graphic (football field) that represents the prediction will highlight. The Prompt will then flip to the next question and new set of options. FIG. 16 shows an example graphical user interface adapted to allow a player to predict which part of the field the next play will go across the field.

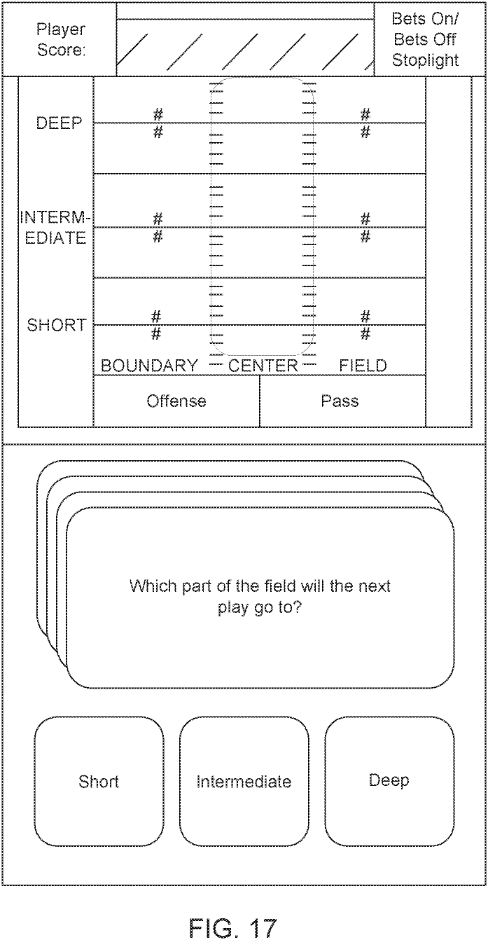

Fourth, players will be prompted to predict the vertical play direction: which part of the field will the next play go to (down the field)? Players can make their prediction either by swiping up, left or right on the screen or by clicking the short, intermediate, or deep boxes. Once players make their prediction, the section of the gridiron graphic (football field) that represents the prediction will highlight. The Prompt will then flip to the next question and new set of options. FIG. 17 shows an example graphical user interface adapted to allow a player to predict which part of the field the next play will go down the field.

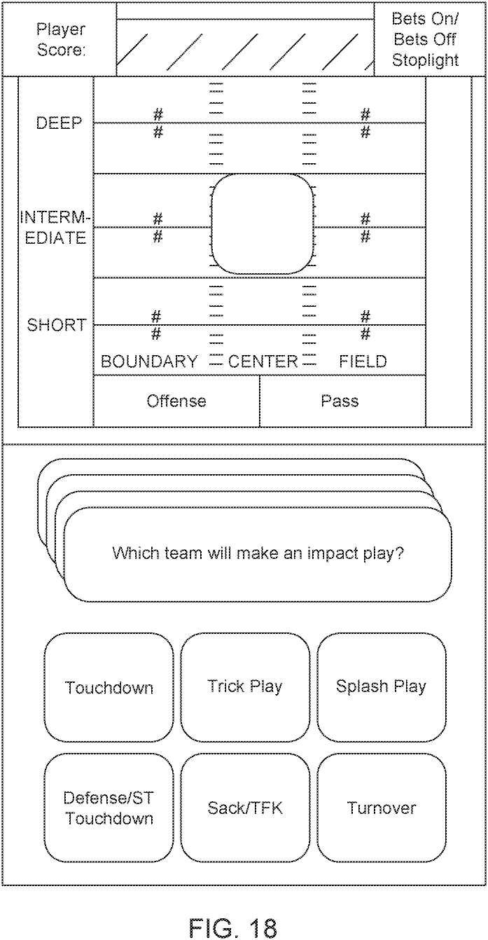

Fifth, players will be prompted to predict whether something particularly exciting or impactful will happen on the play: which team will make an impact play? Players can make their prediction by clicking the touchdown, trick play, splash play, defense/special teams touchdown, sack/tackle for loss, or turnover boxes. Once players make their prediction, the section of the gridiron graphic (football field) that represents the prediction will highlight. The Prompt will then wait for the play to take place. Once the play is over, the display will show results including the actual play result as well as whether each prediction won or lost. FIG. 18 shows an example graphical user interface adapted to allow a player to predict whether something particularly exciting or impactful will happen on the play, which team will make an impact play.

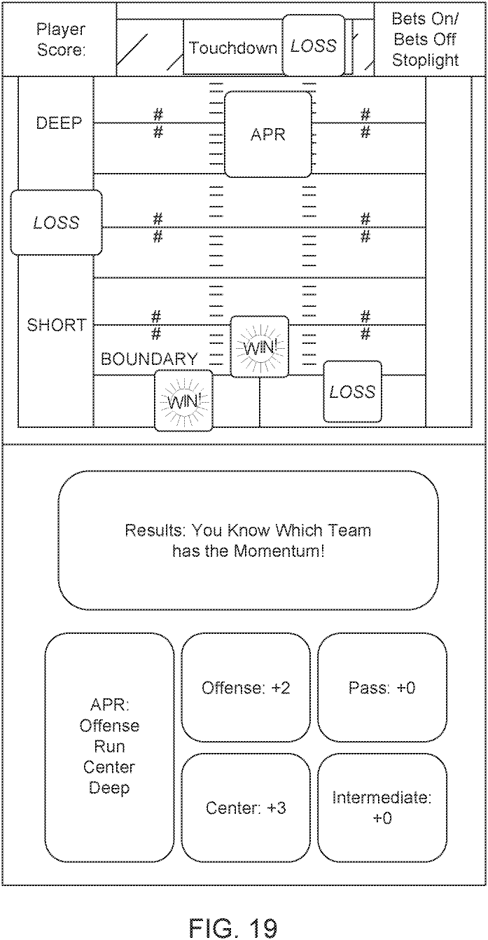

FIG. 19 shows an example graphical user interface adapted to show results of the player’s one or more predictions.

The free-to-play Fantasy Coaching Game may include various points or scoring systems. For example, the following points or scoring systems may be provided:

Example Point System 1: Static points with multiple opportunities to win. Assign each core prediction type (play result, play type, and play direction) a point value corresponding to the number of possible outcomes there are. Play result predictions are worth 2 points because there are 2 possible outcomes: offense or defense win. Play type predictions are worth 2 points because there are 2 possible outcomes: run or pass. Horizontal play direction predictions are worth 3 points because there are 3 possible outcomes: left, center, or right. Vertical play direction predictions are worth 3 points because there are 3 possible predictions: short, intermediate, and deep. In this point system, points are intentionally designed to be static on every play instead of dynamic or responsive to game situations. The purpose of this point system is to lower the barrier to entry to making predictions and to make it easier for users to form habits around predicting play by play outcomes regularly. Static points can simplify the introduction to the game for sports fans who are interested in play by play predictions but do not understand odds or money lines or other traditional sports book offerings. If players can focus on figuring out which outcomes they expect instead of focusing on the value of each outcome if it occurs, static points can the lower user effort necessary to make decisions. Therefore, static points will enable beginner players to make more predictions and build prediction habits. Predictions types are also designed to be independent opportunities to earn points instead of parlays. Another goal of Points System 1 is to use the points awarded as gratifying feedback to players. If players can see themselves winning, even on 1 of the 4 prediction types offered on each play, they will build up their confidence that they have the skills necessary to be successful at the game. Player confidence and habits are what will ultimately enable us to convert free-to-play players into bettors, so the results displays in Point System 1 will emphasize the predictions players got correct instead of the ones they got wrong. Point System 1 could introduce odds in the Splash Play Bar.

Example Point System 2: Basic Dynamic Odds. Use roulette-style scoring to set a baseline for odds then adjust odds deliberately in response to a small set of clear cut in-game situations that would influence the likelihood of different outcomes. The core Fantasy Coaching Game Quick Play Bar offers a straight up play result bet (offense or defense) and a parlayed play result and play type bet (offense run, offense pass, defense run, defense pass). 2 boxes represent the play result bet options and 4 boxes represent the play result and play type parlayed bet options. The core Fantasy Coaching Game Gridiron offers a parlayed play result, play type, and play direction bet. 36 boxes represent the parlayed play result, play type, and play direction bet options. Point System 2 uses those numbers as base odds for each prediction type. The play result prediction starts with 2:1 odds on each option. The play result prediction starts with 4:1 odds on each option. The play direction prediction starts with 36:1 odds on each option. From there, Point System 2 classifies in-game situations into categories based on whether certain outcomes are normally probably, more or less likely, or extremely more or less likely. Each categorization will trigger specific adjustments in the odds. The odds increase with each layer of prediction because players predictions are automatically being parlayed together. As players see and come to understand the odds increases with each prediction, they will learn about parlays and the value tradeoffs that come with packaging predictions together.

Base odds on the game board are set, such as 1/36 and make very simple fractional adjustments for situational football. Obvious passing situation = 1/18 in passing boxes, 1/72 in running boxes. Outcomes to respond to: Possession Downs, two-minute drill, red zone, obvious kneeling situations, large score discrepancies: obvious passing situation, obvious running or run out the clock situation. Obvious kneel down situations.

Example Point System 3: Parimutuel. In Parimutuel betting, all player wagers go into a pool, and the pool is shared equally between those who make a winning selection. In the free-to-play Fantasy Coaching Fast Play game, players will stake their points or tokens into the pool instead of real money. When the winning result is determined, the pool of points and tokens will be distributed equally between those who make the winning selection.

Player Tiers:

The Fantasy Coaching No Huddle game includes a set of player tiers designed to offer players both a simplified introductory game mode as well as the opportunity to grow into more advanced gameplay. The introductory tier is called “Assistant Coach”. All players start out at the Assistant Coach level, where they learn which predictions are offered and how each prediction wins. Once players hit a certain point total (TBD), they can level up into the “Coordinator” level. At the coordinator level, players are introduced to dynamic odds and parlays. Once players hit a certain point total (TBD) at the Coordinator level, they can level up into the “Head Coach” level. At the Head Coach Level, players are introduced to a parimutuel betting model.

The Assistant Coach tier uses Point System 1. This tier is not meant to simulate sports betting so much as it is meant to engage Sports Fans in play-by-play betting. The simplicity of Point System 1 will lower the barrier to entry to the game. Point System 1 can build players’ confidence by giving them points for any part of a prediction they get correct.

The Coordinator tier uses Point System 2. It will introduce a basic dynamic odds system to picot Monday Morning Quarterbacks into Sports bettors by introducing odds, dynamic markets, micro betting, and parlays.

The Head Coach uses Point System 3. The parimutuel betting in Point System 3 will challenge Monday Morning Quarterbacks to think about markets and by looking for value in distinguishing their predictions from others while still being correct. In the Head Coaching tier, players do not just win by being right, but also by being smarter than everyone else.

Software System: The application is divided into 4 modules, each with a unique set of privileges and function.

Administrator: This module can only be accessed by the application owner and would have the highest privileges to the application. This module allows the application owner or administrator to create and manage the game manager/host profiles, grant them relevant permissions, and set game rules and conditions to apply the rules. It would also allow the administrator to ban or reinstate players if needed. Any updates or new versions of the applications could be installed and managed through the administrator module.

Manager: The Manager is the game host and could also fulfill the role of a referee. The manager would open and close betting periods, open and close sections on the game board for placing bets, and apply the rules based on certain conditions. Most of the rules would be automatically applied based on the game progression; however, the manager could override certain rules or manage their application. After each play, the manager acting as a referee could determine and certify the result and announce winners and losers on the screens.

Player: The player module allows players to create and manage their profiles. They could link to the casino’s player tracking systems if available. The module would allow players to place bets, view outcomes, track their individual progress, and handle wins and losses. This module will keep track of player points, play history, preferences, tier level, and demographic information.

Cashier: This module compares the player wagers against the actual play result. The cashier module will be configured to determine payouts for wins and to collect losses. This module will also log all transactions for reporting and auditing purposes. The cashier module could allow manual intervention when implementing certain rules related to delays or reversals and could handle exceptional situations.

Each individual play of the football game that is the subject of wagering in the Fantasy Coaching Fast Play game can be considered an independent event. The Fantasy Coaching Fast Play application would receive data about each individual play of the football game by connecting to an Application Programming Interface (API) and Web Service. An API and Web Service would allow the application to get near real-time game progression/play data. An API is a series of web enabled functions and programs that allows two different applications to exchange data over the internet using HTTP. The application would connect to the API endpoint (a web address or port) to call the relevant function or program. The programs usually have a set of input parameters which enable accurate filtering and sorting of data. As the application evolves, heavier use of APIs could reduce the manpower needed to run the application and move the game towards a more fully automated, easily scalable model. The APIs usually provide detailed documentation regarding the various functions available and how to connect to them.

An example of an existing, near real-time API is SportsDataIO. SportsDataIO covers tens of thousands of sporting events throughout the year, and services all verticals, including fantasy, sports betting, broadcast, media, and predictive modeling. The company’s APIs allow for live play-by-play updates for NFL games that are typically provided 15-20 seconds after the TV broadcast. The play-by-play data includes a breakdown of every play: a description of the play, the players that were involved, the stats earned by involved players on the play, the result of the play, and starting/ending game state info (starting/end down and distance, etc.).

The Fantasy Coaching Fast Play application Manager Module uses API play-by-play updates about the down and distance of an upcoming play, the yard line the upcoming play will start on, and the time on the game clock leading into the upcoming play to initiate betting periods on the Player Modules. The Manager Module uses API play-by-play updates about the yards gained or lost on a play; information about whether the play was a run or a pass, information about whether the play was a scoring play, first down play, etc; and information about which part of the field the play ended on to establish and certify the actual play result on the Fantasy Coaching Fast Play UI. The Cashier Module compares the actual play result to player predictions/wagers, determine payouts for correct predictions (wins), and collect incorrect wagers (losses). In this embodiment, payouts will take the form of points or tokens according to the Fantasy Coaching Fast Play points systems. Player predictions, actual play results, wins, and loses will all display on the Graphical User Interface.

The Fantasy Coaching Fast Play application Graphical User Interface features a sequence of prompts for players to make predictions about, a menu of selectable possible predictions for each prompt, and a graphical display of a football field that registers each layer of player predictions.

Prediction Prompts: The prediction prompts display on the Fantasy Coaching Fast Play UI as a stack of cards with a different question on each card. The questions are prompts for players to predict the result of an upcoming play, the play type of an upcoming play, the part of the field an upcoming play will go to, and whether something exciting or momentous will happen on an upcoming play. These questions correspond to the predictions offered in the core Fantasy Coaching game, but they present each prediction in a simplified, sequenced manner.

Possible Prediction Menus: The possible prediction menus display below the prediction prompts on the Fantasy Coaching Player UI as a set of boxes, each representing a different possible outcome that corresponds to the prompt currently displayed. When the prediction prompt prompts players to predict the result of the upcoming play, the prediction menu displays an “Offense” box and a “Defense” box. Players can either click the box or swipe their screens in the direction of the box to register their prediction.

The Prediction Display Gridiron displays on the Fantasy Coaching Fast Play UI as a graphic of the field of play of whichever sport users are making predictions about in the Fantasy Coaching game. As users make their predictions in response to each successive prompt, their predictions display on the Prediction Display Field. Play result and play type predictions display as banners or colored boxes. Play direction predictions highlight the parts of the display field that correspond with the part of the field users predict the play will go to. When the actual play result is established, all predictions will be marked as a “Win” or “Loss” on the Prediction Field Display. The actual play result will also display as a box labeled “APR” on the Prediction Field Display.

The Fantasy Coaching Fast Play UI also displays gameplay information for the user. These include the following:

Player Account: The Player Account displays the user’s point or token total and updates as the user wins or loses tokens on each prediction.

Play Clock: The Play Clock communicates to users when the betting period for each play is open, when the betting period is closed, and what the actual result of the play was. The Play Clock displays a green stop light and the message “Place Your Bets; Bets On” when the betting period is open. The Play Clock displays a yellow stop light and the message “Finalize Your Bets; Bets On” when the betting period is open but is about to close. The Play Clock displays a red stop light and the message “Watch the Play; Bets Off” when the betting period is closed. After a play occurs, the Play Clock displays the actual result of the play, including a message about whether the play was a run or a pass, which direction the play went to across the field and down the field, and whether the offense or defense won the play. The Play Clock displays on the Player Module Graphical User Interface, but the information about “Bets On” and “Bets Off” comes from the Manager Module interpreting and certifying data from the API.

Gameplay begins on the Fantasy Coaching Fast Play application when the Manager Module receives data from the API and Web Service about the starting scenario of an upcoming play from the football game. When the Manager Module receives information about the down and distance, yard line, and time on the game clock, it will open a betting periods on Player Module Graphical User Interfaces. The Play Clock displays “Bets On” and the Prediction Prompt cards display the first play result prediction prompt. Users are able to click their prediction from the possible prediction menu to make their prediction for each prediction prompt. As users make each prediction, their prediction displays on the Prediction Display Field. Once the Manager Module receives information from the API and Web Service that the offenses and defenses are lined up in formation and the Quarterback is under center, it triggers the Player UI play clock to prompt players to finalize their bets. The betting period remains open but will close soon. Once the Manager Module receives information from the API and Web Service that the ball has been snapped and the play has begun, it closes the betting period and triggers the Player UI game board to lock so that players can no longer place any bets. Once the Cashier module receives information about the result of the football play including whether the play was a run or a pass, which part of the field the play went to, and whether the offense or defense won the play, it displays the actual play result on the Player UI Game Board both on the sections of the board that represent the play result and in the Play Clock section. Then, the cashier module compares the actual results of the play to the predictions players made. The Cashier Module marks the player predictions that matched the actual play result as “Wins” on the Player UI and pays out the winnings based on the point system to the Player Account. The Cashier Module marks the player predictions that do not match the actual play result as “Losses” on the Player UI game board and collects points or tokens from player accounts. Then, the Manager Module receives starting scenario information about the next play of the football game and opens up a new betting period on Player UI’s.

The application saves data into a set of tables that would be queried to display data on the screens, as well as perform computations. The database has a series of functions and procedures that would perform storage, data retrieval, calculations, and report generation. The database saves all the game play data retrieved from the APIs, as well as the player bets, on a real-time basis and archives at certain intervals for reporting and auditing purposes. It has a set of tables to enable logging of all events on the interface screens, including user login and logout information with timestamps. Data can be moved to a dedicated reporting database on a predetermined (e.g., daily) basis for Data Analytics and Data Mining tasks. Reports could be generated from the reporting database using Business Intelligence software for Management, Marketing, and Promotions.

The free-to-play system provides a Fantasy Coaching Platform in which components of the system comprise software such as the following:
Authentication for users: Cognito
Betting Console submits bets with API gateway -> SQS queue -> Lambda Trigger -> DynamoDB Receives game scores, play data and offers/messages using IOT -> MQTT based messages
Game state engine: Executes NFL play API, parses game JSON, Writes next play to DynamoDB and IOT Message queues
Play results engine: Gets play results, queries all play bet records for that game play result and determines play bet outcome Writes play results to Dynamodb, updates player balances, sends message to player via IOT MQTT message
Authentication against customer closed system player balance against a closed customer system

### Example Non-Gambling Game Modes

In a Player versus House game mode, players predict the result of as often as each play of the football game. When players predict the plays correctly, they will score points according to a Fantasy Coaching Game Board points system. Game Hosts (non-gambling entities, restaurants, bars, etc.) have access to player scores so they can offer prizes to players as they hit pre-set point benchmarks and to players with high scores. The gameplay for this game mode can follow the same processes detailed in the Fantasy Coaching Game Procedure & the Fantasy Coaching Dealer Procedures. Instead of wagering money, players in this mode can simply mark the Fantasy Game Board with their prediction for the play result and earn points if their prediction matches the actual play result. Players will still be able to mark their predictions by selecting sections of the Fantasy Gameboard on a touchscreen interface, or by placing tokens on a physical game board. The only difference in this mode is the players selections will indicate predictions for points instead of wagers for money.

In one Player versus Player mode, each player who enters a Fantasy Coaching Game receives a set of picks to try to win the most points. Using those picks, players follow a Fantasy Coaching Gameplay Procedure to predict the plays in a football game. Players will earn points for each correct prediction according to a Fantasy Coaching Game Board Points System.

Fantasy Coaching Players can freely predict the play type and play result of any given play of a Football Game. When Fantasy Coaching Players correctly predict the play type or result, they can earn picks on the inside of the Fantasy Coaching Game Board (where players can make layered predictions about play type, direction, and result). Players earn points for each correct prediction on the inside board according to a Fantasy Coaching Game Board Points System. The points or other rewards/status can be used in Player versus Player or Player versus the House variations.

In a Team versus Team mode, Fantasy Coaching Players sign into a Fantasy Coaching Game as a fan of their favorite team (e.g., at the beginning of the game). A Fantasy Coaching Game host tracks & displays the points won by each different fan base. At the end of the game, the fan base with the most points wins some reward from the host (e.g., a gift card, discount, etc.)

As players play Fantasy Coaching throughout a season, Fantasy Coaching profiles track and display each players statistics, such as points won and prediction %’s (and fractions) for play type, play result, play direction, and inside board wagers over time. The profiles can also track each players prediction success when predicting specific teams’ plays. Players can view each other’s Fantasy Coaching Profiles to compare their own prediction success to their friends’ or to football experts’.

In a Player versus Handicapper mode, Fantasy Coaching players can accumulate points and prediction percentages the more they play. Fantasy Coaching profiles can be used to certify “experts” and/or different skill levels of players, such as based on meeting certain benchmarks of percentages of correct predictions over a predetermined number of predictions.

### Game Data

In one embodiment, a Fantasy coaching system enables direct speculation on live events, particularly sporting events, records of past events (e.g., replays, summaries, or randomized presentation of plays of one or more past events), and simulations of events.

The game can receive data from any number of possible inputs. In one embodiment, for example, the game or gaming location can receive a television and/or radio broadcast or other transmission of a game or other live event, such as via a video and/or audio transmission of a football game coverage. In this embodiment, the television broadcast or other transmission may be displayed on one or more displays in a gaming location (e.g., at a casino, sports bar, etc.) alongside, above, or near one or more Fantasy Coaching Game Board, electronic table game, and/or gaming location where users can access the game on a personal device, such as a portable electronic device.

A Manager of the Fantasy Coaching Game (e.g., a casino employee or one or more electronic device such as an electronic table game or personal device) can synchronize the Fantasy Coaching game to the game/event (e.g., by referring to the TV Broadcast to determine which gameplay phase to input into the Manager Input Interface as well as when to input “Bets Off” into the Manager Input Interface.

The TV Broadcast of a football game, for example, displays a Game Clock and the Down and Distance in the Football Game. The video in the broadcast can also capture the chain/sticks crew in the football game, the mechanism used by the football game’s referees to track down & distance. Some broadcasts display the yardline the ball is placed on, but also broadcast display the numbered and lined football field as well as the placement of the football.

The Fantasy Coaching Manager can read the TV Broadcast down & distance display and/or the chain/sticks mechanism displayed in the video feed to determine whether or not the Fantasy Coaching Game is in a General Phase, or a Situational Football: Possession Down Phase.

The Fantasy Coaching Manager can read the TV Broadcast Game Clock display to determine whether or not the Fantasy Coaching Game is in a General Phase, or a Situational Football: 2 Minute Drill Phase.

The Fantasy Coaching Manager can read the TV Broadcast Yardline display and/or the football placement in the video feed of the football field to determine whether or not the Fantasy Coaching Game is in a General Phase, or a Situational Football: Red Zone Phase.

The Fantasy Coaching Manager can watch the football displayed on the field in the TV Broadcasts Video Feed. In one embodiment, when the football is moved by a player to start a play (snapped) after having been placed by the football game’s referee, the Manager can input “Bets Off” into the Manager Input Interface, although other triggers are possible as well.

The Fantasy Coaching Manager can watch the football game’s referees that are captured by the TV Broadcasts’ video broadcast to determine when a play in the football game has ended, and the Fantasy Coaching betting period on the next play can open. The play is marked over when the sideline judges in the football game run into the field of play, blowing whistles and waving their hands over their heads.

The Fantasy Coaching Referee can watch the football, the players, the football game’s referees, and the markings on the field that are captured by the TV Broadcasts’ video feed of the game to determine the actual result i n each play of the game. Details of one embodiment are described in the Dealer Procedure: Detailed Dealer Procedures for electronic table game.

As discussed above with reference to FIG. 1, a television broadcast or other transmission is merely one example transmission of a live football game that may be used.

Football teams, television networks, and stadiums film the gameplay from numerous different angles & viewpoints, capturing different parts of the gameplay. Any of these sources may be used in addition to or instead of a television broadcast or other transmission. Examples of video sources include All 22 (video is a wide camera angle that captures all 22 players on the field throughout the play) from the endzone, All 22 from the 50-yard line, close in views on the different position groups, a sky camera, or the like.

Casinos, other Fantasy Coaching Game Hosts could subscribe to/license a live feed of these different camera angles to give Fantasy Coaching players a different perspective from which to make their predictions/speculation about each upcoming play.

A Red Zone channel or other specialized feed can be used in one or more aspects of a Fantasy Coaching Game, such as for a Red Zone or other aspect of the game. Sports Leagues, notably including the NFL, package all of their simultaneous events into a curated feed to show the biggest moments from each event as they happen (scoring plays, near scoring plays, change of possession plays, plays by notable teams or players, etc.)

Casinos and other Fantasy Coaching Game Hosts can offer Fantasy Coaching Players the opportunity to make predictions synchronized to those kinds of curated feeds of simultaneous events like the NFL’s Red Zone Channel.

Live sporting events, including football, are broadcast over the radio by broadcasting teams of at least one play-by-play announcer, one “color” commentator, and one sideline reporter. The Play-by-play announcer, who describes the gameplay in the event, typically introduces each play by describing the scenario in which the play will take place. In football, that scenario can include describing the down and distance to a first down or touchdown, the yardline the ball is placed on, and the time remaining on the game clock. They also mark the snap of the ball to start each play by saying different variations of, “X quarterback takes the snap.”

Fantasy Coaching Game Managers can listen for the Play-by-Play announcer’s down and distance, yardline, and game clock calls to determine which gameplay phase to input (general versus situational) and open a betting period.

Fantasy Coaching Game Managers can listen for the Play-by-Play announcer to mark the snap of the football to input “bets off” and close the betting period.

The Play-by-Play announcer can also include enough salient details in their description of what happens on each individual play of a football game for a Fantasy Coaching Referee to mark the actual play result on the Fantasy Coaching Game Board. Play-by-Play announcers describe whether the offense runs (“handoff to x player”) or passes (“x quarterback throw to y receiver is complete/incomplete”) the ball, as well as direction (left/right) and the yards gained/lost on a given play.

Fantasy Coaching Referees will listen for the Play-by-Play announcer’s run/pass, yards gained/lost, and directional calls to input the actual play result. In one embodiment, if the Play-by-Play broadcasts provides incomplete descriptions of any aspect of the play, especially directional aspects, any speculation on whatever element of the play was not included in the description of the play is considered a wash. For example, if an announcer says a pass was incomplete but does not specify how far downfield the ball was thrown, Fantasy Coaching Cashiers will recognize the speculation on Run/Pass and Offense/Defense, but not Short/Intermediate/Deep.

Radio Broadcasts can also be synchronized to Fantasy Coaching Game Boards adapted to the medium: a game board that offers expanded play type and play result speculation, but less play direction speculation.

Color commentators and sideline reporters offer insights into team strategy and player performance that Fantasy Coaching Players can use to supplement their speculation.

Sports broadcasting and digital media companies that track and report the Play-by-Play gameplay of sporting events display a Play-by-Play gameplay in the sporting event in a Gamecast format. The Gamecast format typically includes a scoreboard visual similar to the scoreboard shown on a TV Broadcast. For football Gamecasts, the scoreboard visual shows the Teams & Team Scores, the down and distance for the upcoming play, the yardline the ball is placed on, and the time remaining on the game clock. Below or alongside the scoreboard, Gamecasts also display a digital image of a football field onto which the Gamecasts overlays information about what happened on each individual play. The information includes play type (run versus pass), yards gained or lost on the play, and play direction (left, right, middle, sometimes field, middle, boundary).

To synchronize Fantasy Coaching Gameplay to a Gamecast Game Data Input:
The Fantasy Coaching Manager can read the Gamecast down and distance display and/or the chain/sticks mechanism displayed in the video feed to determine whether or not the Fantasy Coaching Game is in a General Phase, or a Situational Football: Possession Down Phase.
The Fantasy Coaching Manager can read the Gamecast Game Clock display to determine whether or not the Fantasy Coaching Game is in a General Phase, or a Situational Football: 2 Minute Drill Phase.
The Fantasy Coaching Manager can read the Gamecast yardline display and/or the football placement in the video feed of the football field to determine whether or not the Fantasy Coaching Game is in a General Phase, or a Situational Football: Red Zone Phase.
The Fantasy Coaching Manager can watch for the Gamecast’s Football field digital image to update with the play result information. As soon as the Gamecast starts to update, the Manager will input “Bets Off” into the Manager Input Interface.
The Fantasy Coaching Referee can watch the Gamecasts football field digital image that displays play result information to input the actual play result into the Referee Input Interface. Details are described in the Dealer Procedure: Detailed Dealer Procedures for ETG Game.

An at-game spectator (see, e.g., FIG. 1), such as a “boxman” may be present at the live event (e.g., football game) and be in communication with the gaming site and/or one or more gaming devices to help synchronize the operation of the game. An embodiment of a game with a “boxman” is described in more detail herein.

In another implementation, past game clips (e.g., clips of individual plays) may be randomized or otherwise arranged into a simulated game. For example, a database of football play video clips, potentially from all football games captured on video (all past NFL games, FBS, FCS, CFL, XFL, etc.) can be built and provided for use in the game. For each clip, a starting scenario can be pre-determined (down and distance, yardline, time on game clock, game score) and actual play result (play direction, type, and result) for each video clip play can be stored in the database. Each play can be categorized and packaged by starting scenario and/or play result (i.e. build a deck of video clips that is entirely made up of 3rd down plays or Red Zone plays or passing plays, etc.) in the database. Video clip plays can be packaged by more fan-centric factors like Super Bowl Moments, plays by a specific team, plays by a specific player, unlikely plays, trick plays, etc. Multiple (e.g., 100 or 1,000) play decks for each scenario/category, all randomized, mixed, matched, and shuffled to prevent memorization or pattern recognition by players can be created. A Fantasy Coaching Game can be synchronized to the clips. In this manner, the gambling experience can be offered at any time by simulation even when a live event is not available.

Each player and/or group of players can be offered one Game Data Input Display (video screen) that displays the video clip football plays. The Game Data Input Display screen can be linked to one more Player Input Device(s) that displays the Fantasy Coaching ETG Board (allows players to place wagers on their predictions). The Player Input Device can enable players to select the video clip deck they want to play via a selection screen. Once the Player selects a deck of video clips to play, the Game Data Input Display shows the first play from the deck (randomized/shuffled), paused at the start of the clip so the player can see the Offensive and Defensive formations as well as the starting scenario of the play.

The Player Input Device can open a 25 or 40 second (decision pending) betting period for the Player to input their prediction and/or wager amount on the parts of the Fantasy Coaching Game Board that are available depending on the starting situation in the video clip play (general vs. situational phase). During the betting period in one embodiment, a Game Data display shows some information about the starting scenario for an upcoming play (e.g., formations displayed as x’s and o’s, down & distance, etc.), but does not display all information about the upcoming play (e.g., which teams are playing, which week and year the game is played in, actual video of the play frozen or otherwise) to avoid players recognizing a play they have already seen.

Once the betting period clock hits 0, the Player Input Device locks (stops accepting bets or prediction adjustments). The Game Data Input Display plays the video clip of the football play through the end of the play. A computer processor component in the Fantasy Coaching Game system determines if the player prediction was correct or incorrect by comparing the player prediction against actual play result data (pre-determined in the categorized football play video clip database. If Player Prediction matches actual play result = Player Wins → multiply player wager by odds table → payout the product. If Player prediction does not match the actual play result → Collect player wager.

This version of the Fantasy Coaching game does not need a Manager or a Referee because the game phase (general versus situational football phase) and the actual play result (play type, direction, and result) can both be read by a computer processor from the categorized starting situation and play result data attached to each video clip in the video clip database.

The computer processor mechanism: allows the player to select a video clip deck from a menu of categories (3rd downs, passing plays, etc.), randomly displays a play video clip from the deck on the Game Data Input Display, paused at the beginning, pauses at a point where the player can see the pre-snap formations of the offense and defense in the video clip, as well as the starting situation, opens a 25 second betting period on the Player Input Interface as soon as the paused play video clip displays on the Game Data Input Display.

A Player Input Interface can display the Fantasy Coaching Game Board for players to directly enter their predictions and wagers.

A computer processor inputs a general phase or situational football phase into the Player Input Interface to start the betting period (depending on the starting situation in the video clip), and only makes the areas of the Fantasy Coaching Board available for predictions that are part of the gameplay phase that is input. The computer processor can also freeze or otherwise immobilize Player Input Interfaces after the 25 second betting period ends, play the full football play video clip on the Game Data Input Interface, compare player predictions/wagers to the actual play result (from video clip database), pay out wins, and collect losses.

The processor can also control a Betting Protocol once the computer opens betting. A player, for example, can tap or otherwise select a button or other selector of the player input interface that represents a wager to enter. A wager display can be opened → players enter/type the dollar amount of their wager or players can enter wagers by dragging the number and type of video poker chips that represent the dollar amount of their wager into the box on the Player Input Interface that represents their prediction.

A computer mechanism (e.g., processor) can ensure that player predictions/wagers are clearly placed within the box that accurately represents the players’ prediction/wager by:
Touchscreen component or buttons
Clearly Labeled displays
Memory component to record player entries
New, randomized (or not) computer simulation plays

In another embodiment, video games (e.g., Madden) and computer models can be used to simulate potential live events (football games) at a high level of specificity and authenticity. A video game can be adapted to display and simulate full-length football games involving 11 players on offense, 11 players on defense. The game can simulate the virtual offense running an actual play call against the virtual defense, also running an actual defensive call. It simulates each of the 11 players in each unit performing their actual responsibility in the called play at the represented players set skill level. It shows the play unfold according to its model and shows the actual play result. Throughout the course of these simulated games, the systems are able to continually track and update the starting situations of each play (down and distance, ball placement yardline, game clock) and actual play results (yards gained/lost, run versus pass, direction of the play).

In one embodiment, for example, a Fantasy Coaching Game can be synchronized to video game simulations/computer models of football games. A video game simulation/computer model can generate a visual of an offensive team against a defensive team. It also generates a play call for the Offense and the Defense. The visual of the team’s starting formations and the starting scenario of the play are displayed on the Fantasy Coaching Game Data Input Display, paused.

A computer processor can input a gameplay phase (general or situational football) into the Player Input Device to open a 25 second betting period on the device. The computer processor can determine which gameplay phase to input by reading the starting scenario data from the video game simulation and cross referencing the data against the fantasy coaching criteria for each gameplay phase.

The betting period offers the types of predictions that are available in the type of phase that is input according to the Fantasy Coaching Procedure. After a betting period (e.g., 25 seconds), the computer processor can input “Bets Off” into the Player Input Interface (freezing all betting) and run the video game simulation/computer model on the Game Data Input Display (i.e. runs a simulated play).

The computer processor compares player predictions/wagers against the actual play result. The processor is adapted to pay out wins (prediction that match result) and collect losses (predictions that do not match the result). The computer processor determines the actual play result by reading the data in the video game simulation (run/pass, yards gained/lost, direction of the football). The computer processor loops the above steps for the remaining plays in the game. Fantasy Coaching Table Game Synchronized to Live Event

In one embodiment, a system and method for synchronizing a Fantasy Coaching Table Game to a live event is provided. In this embodiment, one or more player can join the game via an electronic table game, such as described above. In one embodiment, for example, the player(s) can do the following:
sit at/approach a Fantasy Coaching Player Input Interface (video screen), and
input the money they will wager into the machine.

A processor is adapted to provide a process for opening a Betting Period, collecting predictions, and closing the Betting Period.

In one embodiment, a Manager can categorize the phase of Fantasy Coaching Gameplay with “General Gameplay” or “Situational Football” designations by:
Referencing the game data input for down and distance
   1st down or 2nd Down are NOT Possession Down Gameplay
   3rd Down or 4th Down = Possession Down Gameplay
Referencing the game data input for yard marker
   Any yard marker outside the 20-yard line from the reference point of the Offense Driving into the End Zone = NOT Red Zone Gameplay
   Any yard marker inside the 20-yard line from the reference point of the Offense Driving into the End Zone = Red Zone Gameplay
Referencing the game data input for the Game Clock
   Any time outside of 2 minutes in the 2nd or 4th quarter = NOT 2 Minute Drill Gameplay
   Any time inside of 2 minutes in the 2nd or 4th Quarter = 2 Minute Drill Gameplay

The Manager opens betting by inputting the Gameplay Phase into the Manager ETG Interface. The Manger can enter “General Gameplay” into the Manager Interface (press a button, touch a screen, etc.) if the Football Game is in its General Gameplay (Come out Roll) Phase (not in a Situational Football situation). A “General Gameplay” input from the manager will display the entire Fantasy Coaching Game Board on Player Input Interfaces, allowing players to wager on all predictions available on the board. The Manger enters “Situational Football Gameplay: (specific situation) (possession down, 2 minute drill, red zone)” into the Manager Interface (press a button, touch a screen, etc.) if the Football Game is in a Situational Football Gameplay (point established) Phase.

In one embodiment, a “Situational Football Gameplay” input from the manager can display only the sections of the Fantasy Coaching Game Board that layer the specific predictions available to players during each situation together on Player Input Interfaces, allowing players to only wager on those specific predictions/parlays available on the board. This can involve separate screens for each situation, a zoom in effect on certain sections of the board depending on the situation, or a locking effect on the areas of the board that are not available in different situations in some embodiments.

A Betting Protocol can also be provided once a Manager opens Betting. For example, Players can tap the box/press the button of the player input interface that represents their prediction to enter a wager. A wager display opens → players type the dollar amount of their wager, or players enter wagers by dragging the number and type of video poker chips that represent the dollar amount of their wager into the box on the Player Input Interface that represents their prediction. A computer mechanism (e.g., processor) ensures that player predictions/wagers are clearly placed within the box that accurately represents the players’ prediction/wager by: a touchscreen component or buttons, clearly labeled displays, and a memory component to record player entries.

In one embodiment, Player Detailed Betting Options for each Gameplay phase are provided. For example, the options may include the following:
If Fantasy Coaching Gameplay is in its General Gameplay Bets On phase, players can predict the play type (run or pass) (alone) by placing a wager marker (poker chip) in the Run box or the Pass box of the Fantasy Coaching Board,
If Fantasy Coaching Gameplay is in its General Gameplay Bets On phase, players can predict the play type (run or pass) combined with the play result (Offense or Defense Win) by placing a wager marker (poker chip) in the Run box or the Pass box of the Fantasy Coaching Board, and
Continued for all betting options.

The Manager closes betting by inputting “Bets Off” into the Manager ETG Interface. For example, a Manager ETG Interface triggers all player input interfaces to freeze as soon as Manager inputs “Bets Off.” Player input devices can continue to display all player predictions and wagers that were already input. Player input devices do not allow players to add, remove, or change predictions or wagers until the Referee inputs the actual play result into the Referee input interface, the Cashier (person or computer mechanism) collects losses and pays out wins, and the Manager inputs a new Gameplay Phase to open betting for the next play into the Manager Input Interface.

In one embodiment, all Fantasy Coaching Gameplay halts for Dealers and Players to observe the play in the football game.

A process for establishing the actual play result is also provided. For example, a Referee watches the Football Game (via X game data input) and categorizes the play in the football game with run/pass, offense/defense, Field/Middle/Boundary, and Short/Intermediate/Deep designations by:
The House determines that a play in the football game is over by either: listening for the whistle from the referee in the football game that ends the play, watching for the sideline judged in the actual football game to run into their field with their hands up to spot the football for the next play (or watching for touchdown, 1st/2nd/3rd/4th Down signals, or penalty flags), or Watching for the player carrying the football in the actual game to be tackled, run out of bounds, or score a touchdown, or watching for a forward pass to hit the ground incomplete.

The House can determine the play type (run versus pass) by selecting a Run if the ball is carried throughout the play (not thrown), or the ball is only thrown/tossed laterally or backwards through the air. The House can also determine the play type as a Pass if the football is thrown downfield/forwards at any point during the play (whether the ball is caught after the throw or not).

The House can determine the yardage earned or lost on a play in the football game by a method such as by determining the yardage by subtracting the Ball location on play beginning from the Ball location on play ending or by a determination based/received from a live game transmission.

The House can determine the lateral position the play in a football game play end such as by referencing the football game data input, or comparing the position of the player with the ball to the sidelines and hash marks on the football field. In one embodiment, for example, the House can determine the lateral position of the play (left, right, center) by placement of the ball by an official post play.

The House can determine the vertical position the play in a football game play end such as by referencing the football game data input, or comparing the position of the player with the ball to the original line of scrimmage, the orange sticks, the lines and yard markers on the football field, and determining where the ball contacts the ground on an incomplete pass.

The Referee can communicate the categorized results of the football game to players by inputting the categorized results into the Referee Input Interface, which then display on an Actual Play Result Video Screen and/or all Player Input Devices. For example, the Referee can input in the Run box of the Fantasy Coaching board if the team runs the ball instead of attempting an forward pass. The Referee can input in the pass box of the Fantasy Coaching board if the offensive team throws the ball forward (attempts a forward pass).

The Referee can input in the Offense box of the Fantasy Coaching board if the offense gains more than 4 yards from the line of scrimmage or earns a first down or touchdown on a running play. The Referee can input in the Defense box of the Fantasy Coaching board if the offense does not gain at least 4 yards from the line of scrimmage or earn a first down or touchdown on a running play. The Referee can input in the Offense box of the Fantasy Coaching board if the offense gains more than a predetermined number of yards (e.g., 3, 5, or 7 yards) from the line of scrimmage or earns a first down or touchdown on a passing play. The Referee can input in the Defense box of the Fantasy Coaching board if the offense does not gain at least the predetermined number of yards (e.g.,, 3, 5, or 7 yards) from the line of scrimmage or earn a first down or touchdown on a running play.

In one embodiment, a computer processor combines the Referee inputs for play type, play result, and play direction to determine inside box of the Fantasy Coaching Board that occurred.

In another embodiment, the Referee Layers the Actual Play Result designations together by inputting on the inside of the Fantasy Coaching Table grid box that represents the correct combination of designations according to the Referee’s markers on each of the four margins. Each margin around the grid represents one of the four designations. (See, e.g., FIG. 2). Once the Referee marks each of the margins, they can locate the one box that is marked in all 4 margins. The Referee can input on the inside-grid box that represents Process for Cross-Referencing the Actual Play Result with the Player’s Predictions to determine wins and losses. A Cashier can compare the players’ speculative chip placement to the Referee’s Final Chip placement.

If the players’ speculative chips are in the same boxes as the final chips, the player wins, and the Casino pays out according to odds.

If the player’s speculative chips are in different boxes of the Fantasy Coaching board than the Actual Play Result Chips, the player loses, and the House collects the chips for the wager the player placed with their prediction.

A process for paying out wins and collecting losses is also provided. In one embodiment, the process comprises a Cashier that references odds at the table, multiplies the wagered amount by the odds, distributes the corresponding amount to the player via poker chips, and collects the poker chips that marks a player’s incorrect prediction.

In one embodiment, an Electronic Table Game (ETG) comprises a user interface (see, e.g., FIG. 3). In one embodiment, for example, the user interface comprises a display screen for the Manager to Input the game phase (general versus situational). In this embodiment, the operation of inputting the game phase triggers “Bets on” → Opens betting on the player input devices. Inputting the type of game phase (general versus situational) adjusts the wagers available/areas of the Fantasy Coaching Game Board available on Player input interfaces. The display screen displays all predictions and wagers input by all players on all Player Input Interfaces. The display screen is also used to input “Bets Off”, closing the betting period, and locking Player Input Devices. The Manager refers to the Game Data Input to identify when to input “Bets Off”

In another embodiment, the ETG comprises a Referee Input Interface. A display menu represents the different predictions available to Fantasy Coaching players. From the menus, the referee inputs the plays that actually happen in the football game as they happen in the football game. For example, a Play Type Menu includes: Run vs. Pass. A Play Direction Menu includes: Field vs. Middle vs. Boundary | Short vs. Intermediate vs. Deep. A Play Result Menu includes: Offense versus Defense. A Splash Play Menu can also be provided.

The ETG can also display the full Fantasy Coaching Gameboard. A referee can touch the different boxes on the board to input that those outcomes occurred in the current play of the Football game.

A Cashier process can also be provided. If the Manager is responsible for inputting the situation details of the play (complex Manager Input Interface), the cashier process can use those inputs to calculate: Yards gained or lost on the play in the football game, and Manager Yard Marker Input on Play 2 (play currently being predicted) - Manager Yard Marker Input on Play 1 (previous play). The calculation can be used to determine the Play Result (Offense versus Defense) when referenced against the Referee Play Type Input (Run versus Pass) and Referee Splash Play Input (First Down? Touchdown?). The Calculation can also be used to determine the Play Direction Short vs. Intermediate vs. Deep outcome (except if there is an incomplete pass deep).

For calculating payouts, Player Predictions are compared against Referee Inputs. If the Player Input is the same as the Referee Input, the Player wins that wager. The wager is multiplied by the Odds Table to determine a Payout. If the Play Input does not equal the Referee Input, the Player loses the wager. The House/Cashier collects the Wager Amount.

A Player Input Interface is adapted to display the full game board when the Manager inputs a General Phase betting period into the Manager Input Interface. Players can touch each box on the Fantasy Coaching Game Board on a touchscreen interface. When players touch a box, they select that box as their prediction for the upcoming play. In one embodiment, Players can wager on their prediction by either Dragging a digital poker chip to the box that represents the dollar amount of their wager, or the player selecting a box on the Fantasy Coaching game board opens up a screen that allows the Player to enter and/or adjust a wagering amount. The display can show all predictions and wagers from all players laid out on the Fantasy Coaching game board, statistics from the game. The display can also show the Play Clock from the Football Game to give Fantasy Coaching players an approximate timer on the betting period.

### Fantasy Coaching Baseball Game Variation

In a Fantasy Coaching Baseball game variation, Fantasy Coaching players can predict how each at bat, pitch, and in-play hit will unfold. The Fantasy Coaching: Baseball Game Board features three distinct sections that all offer different types of predictions:
The Quick Play Bar: In the quick play bar, players can predict either the Pitcher or the Batter to win the next at bat. They can also predict how many pitches will be thrown during the at bat. The Pitcher wins the at bat when it ends with an out and no runs scored. The Batter wins the at bat when it ends with a hit, an rbi, or a run.
The Diamond: In the Diamond section, players can predict which part of the field a hit by the batter will go to, as well as whether the hit will end in an out or in bases gained by the offense. The area of the field is determined by where the ball is first touched by a fielder.
The Batter’s Box: In the Batter’s Box section, players can predict which part of the strike zone each pitch will go to.
The Splash Play Bar: in the Splash Point Bar, players can predict an offensive or defensive play to end in an exciting way.

Definitions for an example Fantasy Coaching Baseball game variation include the following:
Pitcher Win: The Pitcher wins the at bat when it ends with an out and no runs scored.
Batter Win: The Batter wins the at bat when it ends with a hit, an rbi, or a run.
1-3: An at-bat ends in 1-3 pitches
4-5: An at-bat ends in 4-5 pitches
6+: An at-bat ends in 6 or more pitches
Safe Slide: When a base runner slides into a base and is declared safe by the umpire
Extra Base: When the batting team gains 2 or more bases on the same play.
Splash Out: a force out or a tag out when a fielder gets a player out at the base.
Extra Out: whenever the fielding team gets 2 or more outs on the same play

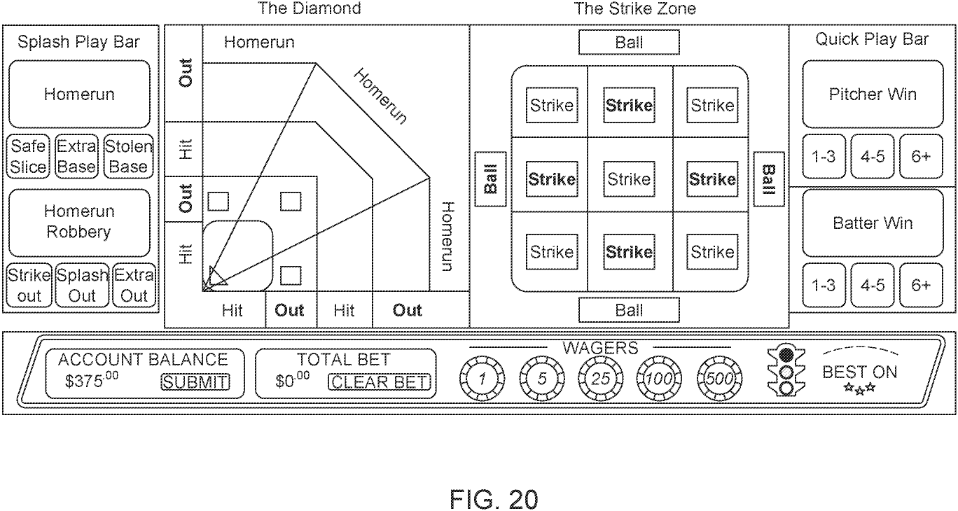

FIG. 20 shows an example graphical user interface adapted to an example Fantasy Coaching Baseball game variation.

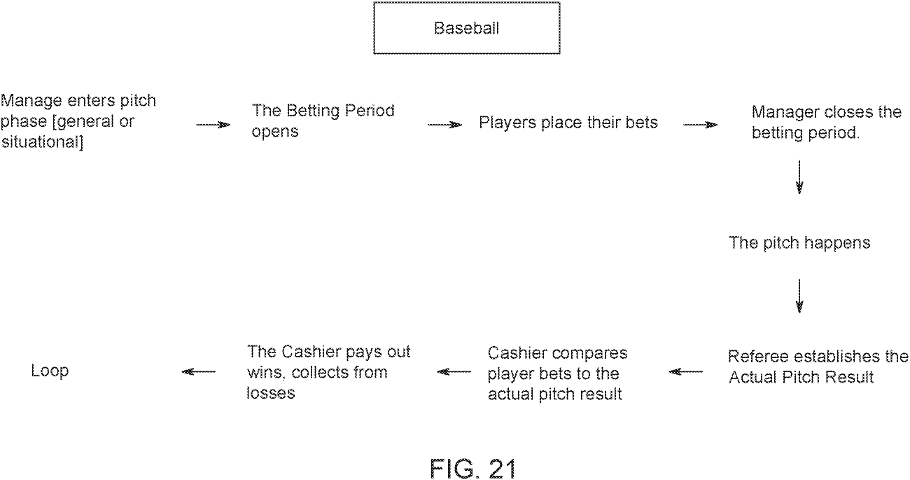

FIG. 21 shows an example Gameplay Flow Diagram adapted to an example Fantasy Coaching Baseball Game Variation.

### Fantasy Coaching Cricket Game Variation

In an example Fantasy Coaching Cricket game variation, Fantasy Coaching players can predict how each delivery in every over will unfold. In one embodiment, a Fantasy Coaching Cricket Game Board features three distinct sections that all offer different types of predictions.

The Quick Play Bar: In the quick play bar, players can predict either the Offense or the Defense to win the next delivery. The Defense wins the delivery when no runs are scored and/or when a wicket is taken. The Offense wins the delivery when the batsmen score 3 or more runs. Deliveries that result in one or two runs are considered neutral. Players can also predict whether plays will be made by the bowler, the fielders, the batsmen running creases, or the batsmen hitting boundaries. When the delivery ends with 0 runs or a wicket taken, the Bowler + Fielders “win” the play. When a delivery ends with 1 or 3 runs, the Fielders “win” the play. When a delivery ends with 2 or 5 runs, the batsmen win the play by running the crease effectively. When a delivery ends with 4 or 6 runs, the batsmen win the play by batting effectively.

The Pitch: In the Pitch section, players can predict which part of the field a hit by the batsman will go to, as well as whether the hit will end in runs scored or wickets taken. The area of the field is determined by where the ball is first touched by a fielder.

The Splash Play Bar: in the Splash Point Bar, players can predict how a wicket will be taken or how a batsman will get out on a particular delivery.

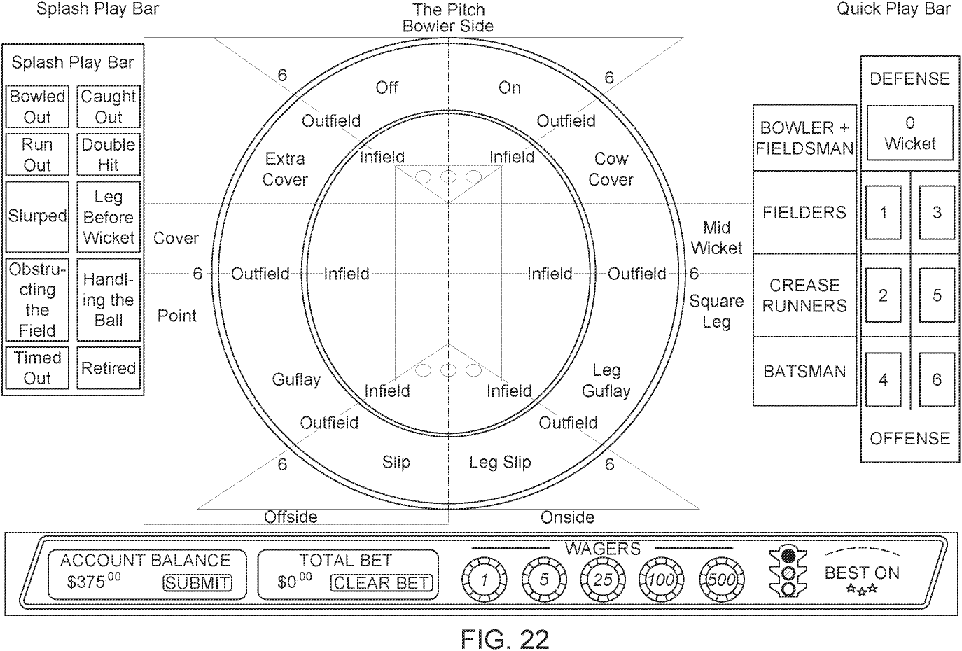

FIG. 22 shows an example graphical user interface adapted to an example Fantasy Coaching Cricket game variation.

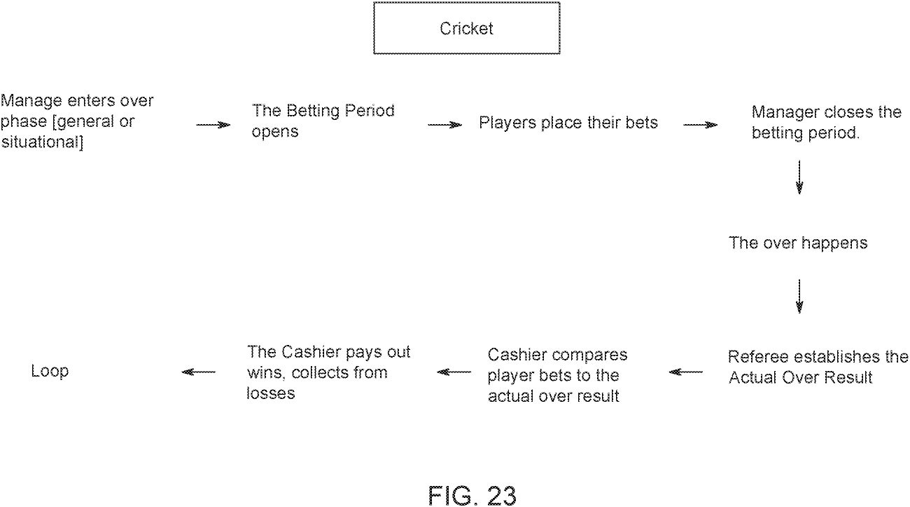

FIG. 23 shows an example Gameplay Flow Diagram adapted to an example Fantasy Coaching Cricket Game variation.

### Fantasy Coaching Tennis Game Variation

In an example Fantasy Coaching Tennis game variation, Fantasy Coaching players can predict how each point of a tennis match will unfold. A Fantasy Coaching Tennis Game Board may feature three distinct sections that all offer different types of predictions.

The Quick Play Bar: In the quick play bar, players can predict either the server or the returner to win the next point. They can also predict how many shots and returns will occur during the point. Every shot hit by either the server or returner, including the serve, counts as 1.

The Center Court: In the Center Court section, players can predict which part of the court the point-winning shot will go to, as well as which player will win the point. The area of the court is determined by where the ball hits to end the point.

The Splash Point Bar: in the Splash Point Bar, players can predict how a point will end; both what type of shot the winner will end on and how the point will be lost.

A Fantasy Coaching Tennis Game variation, for example, may include four distinct phases of Gameplay.

General Phase: Fantasy Coaching: Tennis gameplay is in the General Phase for all points in which neither tennis player has an advantage in the game. In the General Phase, bettors can enter their predictions on all three sections of the game board prior to the start of the point: the Quick Play Bar, the Center Court, and the Splash Play Bar.

Game Point Phase: Fantasy Coaching: Tennis gameplay enters the Game Point phase whenever one of the tennis players gains an advantage in a game and the upcoming point will be a game point. During the Game Point phase, bettors can only enter their predictions in the Center Court or Splash Play Bar sections of the game board. The Quick Play Bar is disabled during the Game Point Phase.

Set Point Phase: Fantasy Coaching: Tennis gameplay enters the Set Point phase whenever one of the tennis players gains an advantage in a game that could decide a set and the upcoming point will be a set point. During the Set Point phase, bettors can only enter their predictions in the Center Court or Splash Play Bar sections of the game board. The Quick Play Bar is disabled during the Set Point Phase. During the Set Point phase, bettors also have the option to split their screens so they can make two different predictions in two different Center Court or Splash Play Bar sections.

Match Point Phase: Fantasy Coaching: Tennis gameplay enters the Match Point phase whenever one of the tennis players gains an advantage in a game that could decide the match and the upcoming point will be a match point. During the Match Point phase, bettors can only enter their predictions in the Center Court or Splash Play Bar sections of the game board. The Quick Play Bar is disabled during the Match Point Phase. During the Match Point phase, bettors also have the option to split their screens into three so they can make three different predictions in three different Center Court or Splash Play Bar sections.

Definitions for an example Fantasy Coaching Tennis Game variation include the following:
Server Win
Returner Win
0-4
5-7
8+
Drop Shot
Volley
Shot Down the Line
Cross Shot
Shot into Net
Double Bounce
Shot Out of Bounds
Double Fault

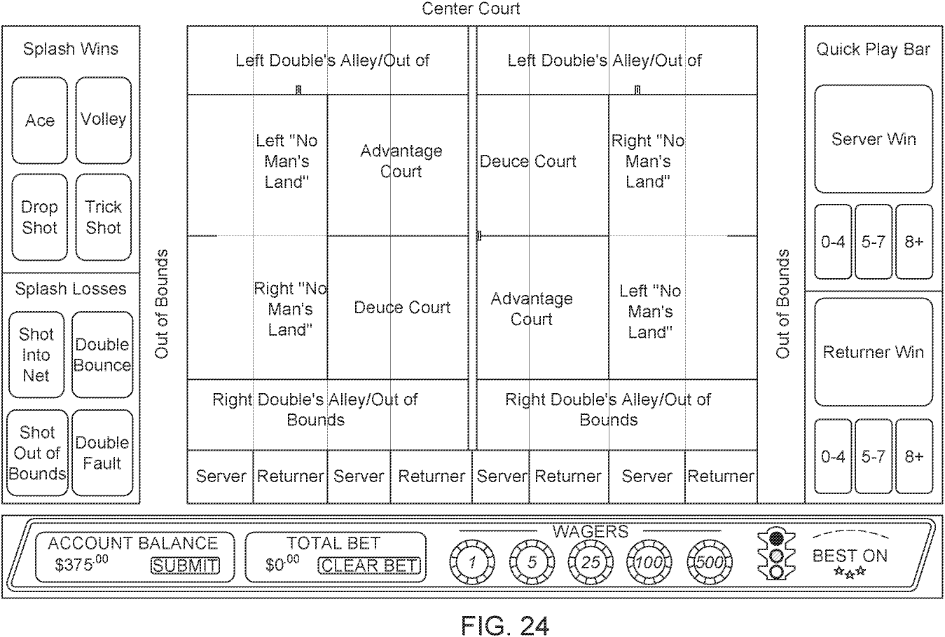

FIG. 24 shows an example graphical user interface adapted to an example Fantasy Coaching Tennis Game variation.

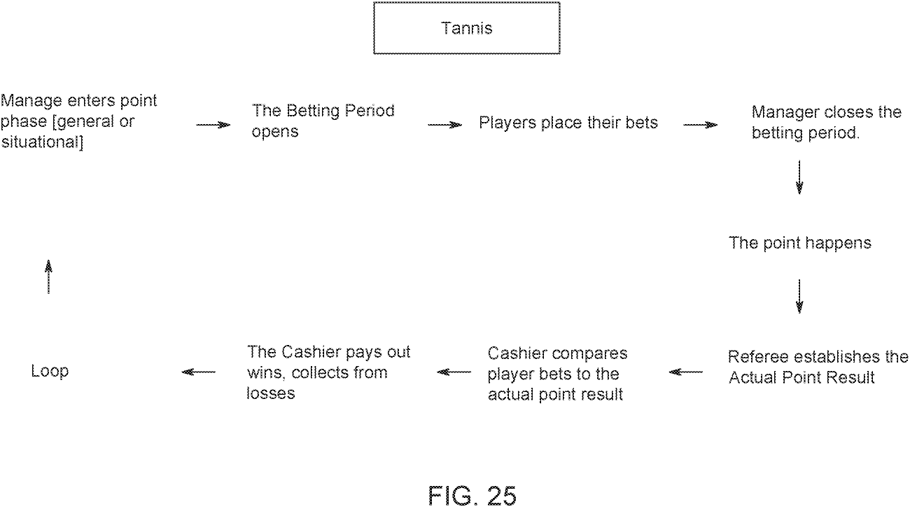

FIG. 25 shows an example Gameplay Flow Diagram adapted to an example Fantasy Coaching Tennis Game variation.

### Fantasy Coaching Basketball Variation

In an example Fantasy Coaching Basketball variation, Fantasy Coaching players can predict how each possession in a basketball game will unfold. The Fantasy Coaching: Basketball Game Board features three distinct sections that all offer different types of predictions.

The Quick Play Bar: In the quick play bar, players can predict either the Offense or Defense to win the next possession. The Offense wins if they score points and the Defense wins if they do not allow points to be scored on the possession. If the Offense makes a shot and scores points, players can also predict if the shot will be a 2 point or a 3 point shot. If the Defense does not allow points to be scored, players can also predict whether the Defense will rebound a missed shot or not allow a shot at all (force a steal, block, shot clock expiration, etc.).

2. The Half Court: In the Half Court section, players can predict which part of the court a shot will be taken from on an upcoming possession, as well as whether the shot will be made, missed, or turned over. The area of the court is determined by where the shooting players’ feet last touch the court before the shot.

The Splash Play Bar: in the Splash Point Bar, players can predict an offensive or defensive play to end in an exciting way. Exciting Offensive plays include Slam Dunks, Alley Oops, and 3-point shots. Exciting Defensive plays include Blocks, Steals, and preventing shots from being taken by forcing the shot clock to expire.

Other opportunities include transitions, assists, and offensive rebounds or other second chance opportunities.

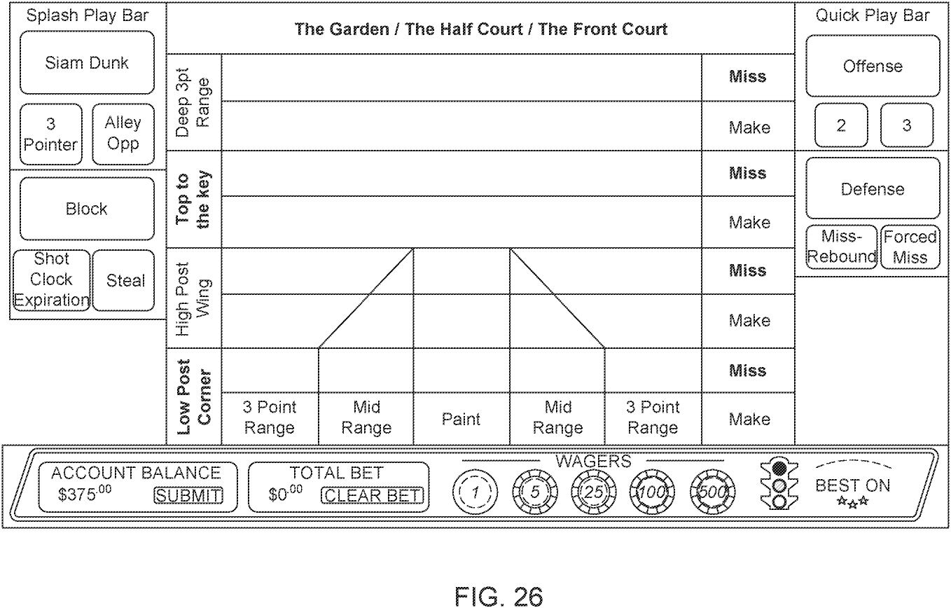

FIG. 26 shows an example graphical user interface adapted to an example Fantasy Coaching Basketball Game variation.

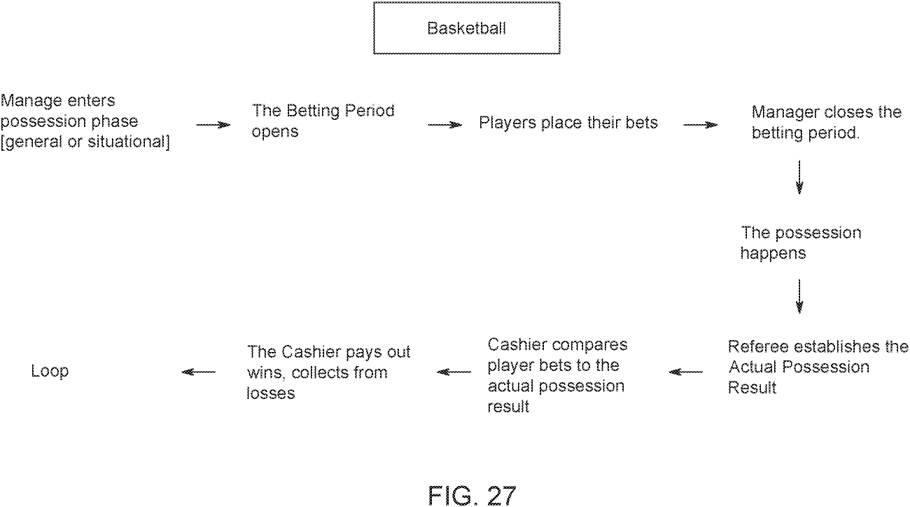

FIG. 27 shows an example Gameplay Flow Diagram adapted to an example Fantasy Coaching Basketball Game variation.

### Fantasy Coaching Glossary

Fantasy Coaching Game Board: Boxes on the board represent potential occurrences in the event.

Fantasy Coaching Game Host:
The entity that is hosting the fantasy coaching game, setting odds for each betting period, accepting wagers and/or predictions, paying out money, points, or rewards, and collecting losses
Potentially the entity that is opening and closing betting periods, determining the phase of Fantasy Coaching Gameplay for each betting period, and establishing the actual play result for each betting period.
The Fantasy Coaching Game Host is also referred to as the House, the Gaming Site, and the Gaming Location

Fantasy Coaching Wagering System - Based on Odds Table (Reference ‘Fantasy Coaching Game Odds’)

Gambling Experience (Game Modes)
Player vs. House - One or more individual Fantasy Coaching Players wager against House set odds on each individual play of a football game
Player vs. Player - Each player who enters a Fantasy Coaching Game receives a set of picks to try to win the most points. Using those picks, players follow a Fantasy Coaching Gameplay Procedure to predict the plays in a football game. Players will earn points for each correct prediction according to a Fantasy Coaching Game Board Points System
Team vs. Team - Players sign into a Fantasy Coaching Game as a fan of their favorite team (e.g., at the beginning of the game). A Fantasy Coaching Game host tracks & displays the points won by each different fan base. At the end of the game, the fan base with the most points wins some reward from the host (e.g., a gift card, discount, etc.)
Player vs. Handicapped Mode - Fantasy Coaching players can accumulate points and prediction percentages the more they play. Fantasy Coaching profiles can be used to certify “experts” and/or different skill levels of players based on meeting certain benchmarks of high correct percentages over a certain amount of predictions.

Non-Gambling Experience
Player vs. House - Players predict the result of as often as each play of the football game. When players predict the plays correctly, they will score points according to a Fantasy Coaching Game Board points system
Player vs. Player - Each player who enters a Fantasy Coaching Game receives a set of picks to try to win the most points. Using those picks, players follow a Fantasy Coaching Gameplay Procedure to predict the plays in a football game. Players will earn points for each correct prediction according to a Fantasy Coaching Game Board Points System
Team vs. Team - Fantasy Coaching Players sign into a Fantasy Coaching Game as a fan of their favorite team (e.g., at the beginning of the game). A Fantasy Coaching Game host tracks & displays the points won by each different fan base. At the end of the game, the fan base with the most points wins some reward from the host (e.g., a gift card, discount, etc.)
Player vs. Handicapped Mode - Fantasy Coaching players can accumulate points and prediction percentages the more they play. Fantasy Coaching profiles can be used to certify “experts” and/or different skill levels of players based on meeting certain benchmarks of high correct percentages over a certain amount of predictions

Game
Football Game – An event used to play the Fantasy Coaching Game
Fantasy Coaching Game – Fantasy Coaching is a house-banked, prediction-game played with the results of football game plays. Before the snap of the ball in a football game the Player is watching, the Player attempts to predict the result of the upcoming play. There are multiple predictions (wagers) that may be made by the player. The play type and play direction wagers enable the player to anticipate the upcoming play call in the football game. The play result wager enables the player to anticipate the effectiveness of the upcoming play call in the football game
Fantasy Coaching Game Host – The whole procedure of a Fantasy Coaching Game Host opening different gameplay phases to players to make predictions about each moment of an event like a football game, closing the gameplay phase before each moments’ outcome is revealed, determining the actual outcome of the moment in the event, and then evaluating whether each players’ prediction was true or not. The Fantasy Coaching Game Host then either pays or otherwise rewards correct predictions, and collects wagers or points from incorrect predictions, depending on the type of game.
Synchronize the Fantasy Coaching Game to the Football Game [Interactive Gameplay]
   (e.g., by referring to the TV Broadcast to determine which gameplay phase to input into the Manager Input Interface as well as when to input “Bets Off” into the Manager Input Interface.)

Game Host Dealer Roles
Boxman/at-event-Spectator – Timestamps when predefined occurrences happen in an event in order to validate that bets placed at off-site locations were placed before the occurrences happen
Cashier – Handles Payouts (person or computer mechanism)
   Pay Out Wagers – Upon players’ win confirmation, House will compensate participants according to odds table and/or points system
   Collect Wagers – Prior to play, House will collect wagers from players
Manager – Receives wagers and Manages play
   (e.g., a casino employee or one or more electronic device such as an electronic table game or personal device)
   can synchronize the Fantasy Coaching game to the game/event (e.g., by referring to the TV Broadcast to determine which gameplay phase to input into the Manager Input Interface as well as when to input “Bets Off” into the Manager Input Interface.
Referee – Confirms the outcomes of each football play (or independent event) and inputs those outcomes into the Fantasy Coaching Game System via I/O Component

Gaming Interface, Player Input Device - Some interface (e.g. a video screen, touchscreen, keyboard, set of buttons, or physical board) that hosts a schematic representation of the Fantasy Coaching Game Board on which each box in the board represents a prediction that a player can make by inputting some wager marker onto that box.
Electronic Table Game (ETG)
Physical Table Game
Physical Game Board
Software Application

Fantasy Coaching Game System
Input/Output Component
   Manger Input Interface
   Referee Input Interface
   Actual Play Result Display
Processor
Memory
Data Storage
Gaming Interface / Player Interface
BUS
Network

Game Data Display- Game Site System - The Fantasy Coaching Game Host will display information about the event that a Fantasy Coaching Game is synchronized to. Players will use that information to inform their wagers and to stay engaged with the event.
The game data may relate to a Live Event, Prior Event, or Simulated Event
   Live Event Transmission
      TV Broadcast
      Radio Broadcast
         Play-by-Play announcer
         “Color” Commentator
         Sideline Reporter
      All 22: (video is a wide camera angle that captures all 22 players on the field throughout the play)
      Special Curated Feeds [Red Zone Channel]
      Gamecast
      Prior Event Transmissions (e.g., replays, summaries, or randomized presentation of plays of one or more past events)
      Past game video clips: potentially from all football games captured on video (all past NFL games, FBS, FCS, CFL, XFL, etc.)
      Video clip database
      Video Clip Deck: (i.e. build a deck of video clips that is entirely made up of 3rd down plays or Red Zone plays or passing plays, etc.) (randomized/shuffled) (3rd downs, passing plays, etc.)
   Simulated Event Transmissions
      Video Game Simulation
      Computer Model
   The information may be a Direct Feed of the Event, a Transmission of the Event, or be relayed by some Spectator at the event.

Game Display/Game Data Display [at gaming site] - A tv screen and/or audio device that relays starting scenario data and actual play result data to Fantasy Coaching Players (E.g. a television broadcast, radio broadcast, or other video feed of a football game displayed on a screen for Fantasy Coaching players to view during gameplay.)

### Game Play Terms

Actual Play Result – The outcome of an independent event (e.g. the play direction, play type, and play result that actually occur on a play of football game)

Betting Period – The period of time between when the Gameplay Phase is established and when the Fantasy Coaching Game Host closes the betting period (e.g. by inputting “Bets Off”) during which players can register their wagers about the upcoming play on the available sections of the Fantasy Coaching Game Board. The time of the betting period may be undefined or defined depending on whether the Fantasy Coaching game is synchronized to a live event, prior event, or simulated event.

Close Calls – In certain instances there may not be enough information for the house to establish the full actual play result (e.g. the House may be able to determine the play type and play result of a football play, but not the play direction). In the event of a Close Call, any wagers placed on the close call are neither collected nor paid out by the Host. No one wins or loses on that particular aspect of the wager.

Combined Predictions - Certain predictions available on the Fantasy Coaching Game Board enable players to predict that more than one potential outcome will occur using the same wager (e.g. a player wagers that the upcoming play will be a run and the offense will win). Depending on House Set Odds, players can make Combined Predictions for more favorable odds and/or more points on the wager.
Combined Predictions are also referred to as layered predictions and Parlays

Correct Predictions - Player predictions are correct when they match the actual play result. Correct predictions are also referred to as wins. When a player’s prediction wins, they receive a payout in money or points.

Fantasy Coaching Game Mechanisms
Free Kick Frenzy – During any free kick in the football game (PAT, kickoff, Safety Punt), the Player may place an Ante Splash Play prediction on the kick. If the wager does not win, the player may keep the same wager on the table and make a new prediction with that wager on the next offensive or defensive snap in the football game. The Free Kick Frenzy ante wager must stay on the table as a wager until it wins or is used to wager on an offensive or defensive snap of the football.
General Betting into Situational Betting – Fantasy Coaching gameplay & available wagers shifts between different phases depending on what is happening in the Event (football game). The specific phases are defined below, but each phase dictates which sections of the Fantasy Coaching Game Board are available for players to wager on.
Individual Situational Betting – When Fantasy Coaching is in one (and only one) Situational Gameplay Phase. Players must play the Gridiron section of the board because the football game is in 3rd or 4th down, Red Zone, or 2-Minute Drill play.
Multiple Situational Betting – When Fantasy Coaching is in more than one Situational Gameplay Phase on the same play & betting period. Players must still play the Gridiron section of the board because the football game is in 3rd or 4th down, Red Zone, or 2-Minute Drill play. However, when this occurs, players can split their Fantasy Coaching Game Boards (similar to the process of splitting aces in blackjack) and input separate wagers on each different game board. Players may split their boards as many times as there are Situational Phases (e.g. if there is a third down play in the Red Zone, but not within the 2-Minute Drill, players can split their board twice. If there is a third down play in the Red Zone and within the 2-Minute Drill, players can split their boards 3 times).

Gameplay Phases
General Phase: any play in the football game that is taking place on 1st or 2nd Down, outside of the Red Zone, and outside of the final two minutes of the 2nd and 4th quarters. When Fantasy Coaching gameplay is in the general phase, players can wager on the Quick Play Bar, the Gridiron, and the Splash Play Bar [any section of the board]
Situational Phases:
   Red Zone/Goal Line - Any play in the football game that is taking place inside of the 20 yard line from the perspective of the Offense driving into an End Zone. When Fantasy Coaching gameplay is in the Situational Football: Red Zone Phase, players can only wager on the Gridiron or on the Splash Play Bar [not on the Quick Play Bar] [not on a Touchdown in the Splash Play Bar]
   2-Minute Drill - Any play in the football game that is taking place inside of the final two minutes of the 2nd or 4th Quarter. When Fantasy Coaching gameplay is in the Situational Football: 2-Minute Drill Phase, players can only wager on the Gridiron or on the Splash Play Bar [not on the Quick Play Bar]
   Possession Downs - Any play in the football game that is taking place on 3rd or 4th Down. When Fantasy Coaching gameplay is in the Situational Football: Possession Down Phase, players can only wager on the Gridiron or on the Splash Play Bar [not on the Quick Play Bar]

Incorrect Predictions - Player predictions are incorrect when they do not match the actual play result. Incorrect predictions are also referred to as losses. When a player’s prediction wins, their monetary wager is collected by the House or they do not receive any points.

Independent Event - Each distinct moment in an event that has its own self-contained beginning and outcome. (e.g. a play in a football game that begins with the snap of a football, ends with the referee’s whistle, and has an outcome that is different from the outcome of the game as a whole). The Fantasy Coaching Game Board and Wagering System enables players to predict the outcomes of independent events.

Live Event - Sporting occasion or other event occurring in real-time that can be synchronized to Fantasy Coaching.

Odds - the ratio between the amounts staked by the parties to a bet, based on the expected probability either way.

Player – Any individual participating in the Fantasy Coaching Game
Different from players in the Football Game that a Fantasy Coaching Game is synchronized too

Player Profiles – House (Casinos, Restaurants, Bars, sports teams) will allow Fantasy Coaching Players to create “Coaching Profiles” to track their success in the Fantasy Coaching Game

Player Statistics – Fantasy Coaching Players’ performance data including Correct Prediction Percentages (e.g. How frequently does a player predict the actual play result compared to the total number of predictions they make in Fantasy Coaching).

Predicted Play Result – Before an independent event actually occurs (or is displayed), Fantasy Coaching enables players to speculate on the outcome of the event (e.g. the play type, play direction, and/or play result of a play in a football game). Player speculation may involve a monetary wager against house set odds, or a non-monetary prediction for points.

Prior Event – Some video or audio recording of independent events that have already happened (e.g. a database of football play video clips, potentially from all football games captured on video (all past NFL games, FBS, FCS, CFL, XFL, etc.). These recordings may be randomized or otherwise arranged into a simulated game synchronized to Fantasy Coaching.

“Pot” of money – the sum of each players’ buy-in minus a percentage that goes to the House as a service fee

Sections of the Fantasy Coaching Game Board
Gridiron – Players can enter wagers in the “Gridiron” during any Phase betting period of Fantasy Coaching Gameplay [General Phase or Situational Phases]. During Situational Phases, players can only wager on the “Gridiron”. Players can use the Gridiron to predict the play type (run or pass) combined with the play direction (Field, Center, or Boundary & Short, Intermediate, or Deep) combined with the play result (Offense or Defense Win) by placing a wager marker (poker chip) in one of the boxes that make up the Gridiron section of the Fantasy Coaching Board.
Quick Play Bar - Players can enter wagers in the Quick Play Bar during any General Phase betting period on Fantasy Coaching Gameplay. Players can only wager on the Quick Play Bar during General Phases. Players cannot wager on the Quick Play Bar during Situational Football Phases. Using the Quick Play Bar, players can wager on the play type and the play result, alone and in combinations.
Splash Play Bar - Players can enter wagers in the Splash Play Bar during any General Phase betting period on Fantasy Coaching Gameplay. Players can only wager on the Splash Play Bar during General Phases. Players cannot wager on the Splash Play Bar during Situational Football Phases. Using the Splash Play Bar, players can predict Trick Plays, Offensive Touchdowns (Cannot pick in the red zone), Defensive Touchdowns/Safety, Turnovers, Sack/Tackles for a Loss.
   Trick Plays – If the ball is touched by 3 or more offensive players (Not including the center on a designed play, and the play results in at least a 10 yard gain)
   Splash Plays – 25+ Yard Gain Pass or Run
   Offensive Touchdown
   Sack/Tackle for Loss
   Defensive Touchdown/Safety
   ◯ Turnover
      Interception
      When the team that did not originally possess the football recovers a fumble

Simulated Event – video games (e.g., Madden) and computer models can be used to simulate potential live events (football games) at a high level of specificity and authenticity. Such simulations may then be synchronized to Fantasy Coaching.

Starting scenario – the starting scenario of a football play involves the Down & Distance to a First Down or Touchdown, the Yardline the Ball is placed on, the Time Remaining in the quarter, the Game Score, and Which team has possession of the football

Success criteria - the definitions for what could happen in a football game on a given play that would make each box on the Fantasy Coaching Board true (e.g., less than ten yards for short, between ten and twenty yards for intermediate, and greater than twenty yards for long). Fantasy Coaching currently defines success criteria for 3 categories of potential football play outcomes; play type, play direction, and play result.
Play Type
   Run – If the ball is carried throughout the play (not thrown), or the ball is only thrown/tossed laterally or backwards through the air.
   Pass – If the football is thrown downfield/forwards at any point during the play (whether the ball is caught after the throw or not). if the offensive team throws the ball forward
Play direction – The location of the football on the field when a football play ends.
   Lateral Locations
      Left / Center / Right
         Left – The football is located between the Left hashmark and the left sideline when the play ends
         Center – The football is located between the Left hashmark and the right hashmark when the play ends
         Right – The football is located between the Right hashmark and the Right sideline when the play ends
      Boundary | Center | Field
         Boundary – At the end of the play the football is located between the hashmark and the sideline of whichever side of the field had more space between the sideline and the spot of the football at the start of the play
         Center – The football is located between the Left hashmark and the right hashmark when the play ends
         Field – At the end of the play the football is located between the hashmark and the sideline of whichever side of the field had less space between the sideline and the spot of the football at the start of the play
      Left | Left Center | Center | Center Right | Right (for potentially more advanced gameplay)
         Left – The football is located between the left sideline and the left numbers when the play ends
         Left Center – The football is located between the left numbers and the left hash marks when the play ends
         Center – The football is located between the left hash marks and the right hash marks when the play ends
         Center Right – The football is located between the right hash mark and the right numbers when the play ends
         Right – The football is located between the right numbers and the right sideline when the play ends
      Vertical Locations
         Short | Intermediate | Deep
         Short – The football is located less than 10 yards downfield from the original ball placement when the play ends
         Intermediate – The football is located between 10 and 20 yards downfield from the original ball placement when the play ends
         Deep – The football is located more than 20 yards downfield from the original ball placement when the play ends
Play Result
   Offensive Win
      Offense Run = 4+ yard run, First Down, Touchdown
      Offense Pass = 7+ yard pass completion, First Down, Touchdown
   Defensive Win
      Less than 4 yard run from Line of Scrimmage (LOS), Prevent a First Down or Touchdown from less than 4 yards, or Turnover
      Less than 7 yard pass from LOS, Prevent a First Down or Touchdown
      from less than 7 yards, Incomplete Pass, Pass Break Up, or Turnover

Team - A group of individuals participating in the Fantasy Coaching Game. Certain Fantasy Coaching Game Modes allow individuals to join teams in which all points scored by individuals add to the teams’ total number of points.

Wager Markers - Fantasy Coaching Players can register their predictions in the Fantasy Coaching Game by placing wager markers on the section of the Fantasy Coaching Board that represents their prediction. A wager marker might be a Poker Chip, Video Poker Chip, Highlighted Box Effect, Dollar Amount, Wager Amount, or some other token.

### Football Terms

Complete Pass – Catch by the offensive team
Downs [1st, 2nd, 3rd, 4th] - A period of action that starts when the ball is put into play and ends when the ball is ruled dead (meaning the play is completed). The offense gets four downs to advance the ball 10 yards. If it fails to do so, it must surrender the ball to the opponent, usually by punting on the fourth down
End Zone – A 10-yard-long area at each end of the field. You score a touchdown when you enter the end zone in control of the football. If you’re tackled in your own end zone while in possession of the football, the other team gets a safety
Field goal - A kick, worth three points, that can be attempted from anywhere on the field but is usually attempted within 40 yards of the goalpost. Like an extra point, a kick must sail above the crossbar and between the uprights of the goalpost to be ruled good
First Down - This is the first in a series of four downs that an offensive team has to gain 10 yards. If a team gains 10 yards, then they will be granted a first down and a new series of four downs
Free Kick - Whenever the football is put into play by a kick or punt instead of by a snap. Kickoffs, Safety kicks, and Safety Punts are all examples of Free Kicks.
Fumble – The act of losing possession of the ball while running with it or being tackled. Members of the offense and defense can recover a fumble. If the defense recovers the fumble, the fumble is called a turnover
Game Clock – the game clock marks the time remaining in the football game
Goal Line – The line marking the entrance of the End Zone
Hash Marks - Two columns of white dashed lines that run the full length of a football field from one end zone to the other near the center of the field. Each hash mark is spaced 1 yard apart, marking all 100 yards of the game field. The Hash Marks are used to spot the football. Before every play, the ball is spotted between the hash marks or on the hash marks, depending on where the ball carrier was tackled on the preceding play (e.g. If a football play ends on the left side of the football field, the ball is placed on the left hash mark for the next play. If a football play ends between the left and right hash marks, the football is placed between the hash marks in approximately the same location for the next play).
Incomplete Pass – A forward pass that falls to the ground because no receiver could catch it, or a pass that a receiver dropped or caught out of bounds
Interception – A pass that’s caught by a defensive player, ending the offense’s possession of the ball
Kickoff – A free kick (meaning the receiving team can’t make an attempt to block it) that puts the ball into play. A kickoff is used at the start of the first and third quarters and after every touchdown and successful field goal
Markers that end a football play – a football play ends when the ball carrier is tackled, a pass is thrown incomplete pass, a player scores a touchdown or runs out of bounds with the football, and especially when the referee blows their whistle & gives a hand signal
Numbers – Every 10 yards on a football field are labeled with large block numbers. The numbers are located between the sideline and the hashmark on both sides of the field. Moving from one end zone to another, the numbers count by 10′s up to 50 at the center, and then count down by 10′s until reaching the following endzone
Out of Bounds – The exterior lines of a football, signifying the boundary of play, stepping outside of these lines with possession of the ball signifies end of play, if ball ends outside of these boundaries end of play is the result
Play Clock – Also called a delay-of-game timer, is a countdown clock between the placement of the ball and snap of the ball, The offense has 40 seconds to snap the ball and play the scrimmage down
Possession
   Offensive Team – Maintains possession throughout their series of four downs, unless a turnover or a punt occurs
   Defensive Team – Gains possession upon a turnover
Pre-snap formations – The alignment of defense and offensive layers prior to the snap, coaches and players alike use these alignments to predict the oncoming play
Punt – A kick made when a player drops the ball and kicks it while it falls toward his foot. A punt is usually made on a fourth down when the offense must surrender possession of the ball to the defense because it couldn’t advance 10 yards
Quarter – The main unit of time measurement for the game. The game of football is played in four quarters, each with a 15 minute game clock. At the end of the game clock for a quarter, there is a brief break before the next quarter begins. Between the second and third quarter is Half Time
Sack – When a defensive player tackles the quarterback behind the line of scrimmage for a loss of yardage
Series – the entire set of plays that a team possesses the football for. When a team first gains possession of the football at the beginning of a series, they receive a set of 4 plays to move the ball far enough downfield to gain either a first down or a touchdown. Whenever a team gains a first down, they receive a new set of 4 plays to continue the series and attempt to score a touchdown.
Sidelines – The outer boundary of the field of play on a football field. If the football or a player holding the football crosses the sideline boundary on a play, the play is over
Snap – The action in which the ball is hiked (tossed between the legs) by the center to the quarterback, to the holder on a kick attempt, or to the punter. When the snap occurs, the ball is officially in play and action begins
Spot of the ball placement (Line of Scrimmage) – Line of scrimmage an imaginary line that extends from where the football is placed at the end of a play to both sides of the field. Neither the offense nor the defense can cross the line until the football is put in play again
   Horizontal: For example, if the ball is placed on a left hashmark (left), on a right hashmark (right), and between the left and right hash marks (center).
   Vertical: the yard line the ball is placed on
Sticks/Chain Gang – Mechanism used by in-football game officials to track the starting position of the football on each play, the location of the First Down or Touchdown line on each play, and the distance between the football and the First Down or Touchdown.
Tackle – To physically interfere with the forward progress of a player in possession of the ball, such that his forward progress ceases and is not resumed, or such that he is caused to touch some part of his body to the ground other than his feet or hands, or such that he is forced to go out of bounds
Tackle for a Loss – When a defensive player tackles an offensive player behind the line of scrimmage for a loss of yardage
Touchdown – A score, worth six points, that occurs when a player in possession of the ball crosses the plane of the opponent’s goal line, when a player catches the ball while in the opponent’s end zone, or when a defensive player recovers a loose ball in the opponent’s end zone
Yard lines – Every yard on a football field is marked through the center of the field by hash marks and on the sideline by white dashes. Every 5 yards on the football field are marked by a solid white line that spans the entire length of the football field from one sideline to another

The Appendices filed with the above-referenced provisional patent application provide additional example embodiments of a system or method of providing a gambling based on an event, such as a live, recorded, or generated event. The embodiments are not limiting, but provide examples of scenarios, systems, methods, user interfaces, or the like. The Appendices are incorporated by reference into this disclosure as if they were fully set forth herein.

An example system and method for obtaining live event data is described in U.S. Pat. Publication No. US20190122482A1, which is incorporated by reference herein.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader’s understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A system for providing a gambling experience for a user based on a live, recorded or computer-generated event, the system comprising:
a user interface; and
at least one processor communicatively coupled to the user interface, the processor adapted to:
receive or determine a predetermined starting situation;
provide a plurality of bet options adapted to predict a result of an action in the event following the predetermined starting situation;
receive one or more bets from at least one user via the user interface;
receive or determine an outcome of the action in the event;
determine a result of the one or more bets based on the outcome of the action in the event, and
provide bet results to the user.

2. The system of claim 1, wherein the event comprises a football game.

3. The system of claim 2, wherein the event comprises a live football game and the action comprises a play of the football game.

4. The system of claim 3, wherein the system comprises an input/output device adapted to receive information related to live plays of the football game.

5. The system of claim 2, wherein the event comprises a plurality of recorded plays of one or more football games.

6. The system of claim 5, wherein the processor is adapted to order and display a series of the plurality of plays via the user interface for a series of betting opportunities based on the series of plays and the processor is adapted to omit one or more recognizable information from the series of plays.

7. (canceled)

8. The system of claim 2, wherein the event comprises a plurality of computer-generated plays and the processor is adapted to order and display the plurality of computer-generated plays via the user interface in a sequence in order to provide a sequence of betting opportunities.

9. (canceled)

10. The system of claim 2, wherein the betting opportunities comprise at least one of the group: situational football mechanisms, a plurality of situations, a quick play opportunity, and betting on one or more field situations.

11. (canceled)

12. The system of claim 2, wherein the betting opportunity comprises at least one of the group comprising: a player versus house betting opportunity, a player versus player opportunity, and a team versus team or team versus house opportunity.

13. (canceled)

14. (canceled)

15. (canceled)

16. (canceled)

17. The system of claim 2, wherein the processor is adapted to receive at least one of the predetermined starting situation and the outcome of the action in the event via an input device.

18. The system of claim 17, wherein the processor is adapted to receive the at least one of the predetermined starting situation and the outcome of the action in the event via a user entering information about the event using the input device.

19. The system of claim 18 wherein the user comprises at least one of a spectator of the event and a user associated with a House associated with the gambling experience.

20. A method for providing a gambling experience for a user based on a live, recorded or computer-generated event, the method comprising:
receiving or determining a predetermined starting situation;
providing a plurality of bet options adapted to predict a result of an action in the event following the predetermined starting situation;
receiving one or more bets from at least one user via a user interface;
receiving or determining an outcome of the action in the event;
determining a result of the one or more bets based on the outcome of the action in the event, and
providing bet results to the user.

21. The method of claim 20, wherein the event comprises a football game.

22. The method of claim 21, wherein the event comprises a live football game and the action comprises a play of the football game.

23. The method of claim 22, wherein the system comprises an input/output device adapted to receive information related to live plays of the football game.

24. The method of claim 21, wherein the event comprises a plurality of recorded plays of one or more football games, the processor is adapted to order and display a series of the plurality of plays via the user interface for a series of betting opportunities based on the series of plays and the processor is adapted to omit one or more recognizable information from the series of plays.

25. (canceled)

26. (canceled)

27. The method of claim 21, wherein the event comprises a plurality of computer-generated plays and the processor is adapted to order and display the plurality of computer-generated plays via the user interface in a sequence in order to provide a sequence of betting opportunities.

28. (canceled)

29. The method of claim 21, wherein the betting opportunities comprise at least one of the group: situational football mechanisms, a plurality of situations, a quick play opportunity, and betting on one or more field situations.

30. (canceled)

31. The method of claim 21, wherein the betting opportunity comprises at least one of the group comprising: a player versus house betting opportunity, a player versus player opportunity, and a team versus team or team versus house opportunity.

32. (canceled)

33. (canceled)

34. (canceled)
